(19) United States
(12) Patent Application Publication
(10) Pub. No.: US 2026/0001277 A1
(43) Pub. Date: Jan. 1, 2026

(54) MULTIANGLE CENTRIFUGE SYSTEMS FOR CLEANING ADDITIVELY MANUFACTURED OBJECTS

(71) Applicant: Align Technology, Inc., San Jose, CA (US)

(72) Inventors: Peter Dorfinger, Woodside, CA (US); Thomas Förster-Romswinckel, Pixendorf (AT)

(21) Appl. No.: 19/252,605

(22) Filed: Jun. 27, 2025

Related U.S. Application Data
(60) Provisional application No. 63/665,969, filed on Jun. 28, 2024.
(60) Provisional application No. 63/726,072, filed on Nov. 27, 2024.

(51) Int. Cl. B29C 64/35; B04B 3/00; B33Y 40/20

(52) U.S. Cl. CPC B29C 64/35; B04B 3/00; B33Y 40/20

(57) ABSTRACT

Systems, methods, and devices for post-processing additively manufactured objects are disclosed herein. In some embodiments, a method includes coupling a substrate to a frame, where the substrate is carrying an additively manufactured object having excess material thereon. The method can further include rotating the frame to remove at least some of the excess material from the additively manufactured object. The method can further include moving the substrate to a plurality of different tilt angles relative to the frame during the rotation of the frame.

### CROSS-REFERENCE TO RELATED APPLICATION(S)

The present application claims the benefit of priority to U.S. Provisional Application No. 63/665,969, filed Jun. 28, 2024, and U.S. Provisional Application No. 63/726,072, filed Nov. 27, 2024, each of which is incorporated by reference herein in its entirety.

### TECHNICAL FIELD

The present technology generally relates to manufacturing processes, and in particular, to multiangle centrifuge systems for cleaning additively manufactured objects.

### BACKGROUND

Additive manufacturing encompasses a variety of technologies that involve building up 3D objects from multiple layers of material. The materials used in additive manufacturing may adhere to the surface of the additively manufactured object, e.g., due to the properties of the materials and/or the geometry of the object. Thus, any excess or unwanted material may need to be removed from the additively manufactured object before the object is ready for further processing and use. However, conventional techniques for removing such material from additively manufactured objects may not be sufficient for highly viscous resins used in certain types of additive manufacturing processes. Conventional techniques may also be poorly suited for cleaning objects with complex geometries or delicate parts. Moreover, conventional techniques may not be scalable for handling large amounts of additively manufactured objects and/or may lack integration with other post-processing steps.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a flow diagram providing a general overview of a method for fabricating and post-processing an additively manufactured object, in accordance with embodiments of the present technology.

FIG. 2 is a partially schematic diagram providing a general overview of an additive manufacturing process, in accordance with embodiments of the present technology.

FIG. 3 is a partially schematic illustration of a system for removing material from additively manufactured objects, in accordance with embodiments of the present technology.

FIGS. 4A and 4B illustrate a system for removing material from additively manufactured objects, in accordance with embodiments of the present technology.

FIGS. 5A-5C illustrate the system of FIGS. 4A and 4B in varying configurations, in accordance with embodiments of the present technology.

FIG. 6 depicts a graphical representation of example force-displacement profiles achievable by the systems described herein, in accordance with embodiments of the present technology.

FIGS. 7A-7C illustrate a system for removing material from additively manufactured objects, in accordance with embodiments of the present technology.

FIGS. 8A-8C are illustrative examples of spring-substrate assemblies, in accordance with embodiments of the present technology.

FIGS. 9A-9D illustrate a system for removing material from additively manufactured objects, in accordance with embodiments of the present technology.

FIGS. 10A and 10B are partially schematic cross-sectional views of a tilt indicator, in accordance with embodiments of the present technology.

FIGS. 11A and 11B illustrate example portions of a system for removing material from an additively manufactured object, in accordance with embodiments of the present technology.

FIGS. 12A and 12B illustrate actuatable substrates in accordance with embodiments of the present technology.

FIG. 13 is a flow diagram illustrating a method for post-processing an additively manufactured object, in accordance with embodiments of the present technology.

FIG. 14A illustrates a representative example of a tooth repositioning appliance configured in accordance with embodiments of the present technology.

FIG. 14B illustrates a tooth repositioning system including a plurality of appliances, in accordance with embodiments of the present technology.

FIG. 14C illustrates a method of orthodontic treatment using a plurality of appliances, in accordance with embodiments of the present technology.

FIG. 15 illustrates a method for designing an orthodontic appliance, in accordance with embodiments of the present technology.

FIG. 16 illustrates a method for digitally planning an orthodontic treatment and/or design or fabrication of an appliance, in accordance with embodiments of the present technology.

### DETAILED DESCRIPTION

The present technology relates to systems, methods, and devices for post-processing additively manufactured objects. In some embodiments, for example, a system for processing additively manufactured objects includes a frame configured to couple to a substrate (e.g., a build platform) carrying an additively manufactured object (e.g., a dental appliance) having excess material (e.g., uncured resin) thereon. The system can further include an actuator configured to rotate the frame to remove at least some of the excess material from the additively manufactured object. During the rotation of the frame, the frame can allow the substrate to move to a plurality of different tilt angles relative to the frame to facilitate removal of the excess material from the additively manufactured object.

In some embodiments, a method includes coupling a substrate to a frame, where the substrate is carrying an additively manufactured object having excess material thereon. The method can further include rotating the frame to remove at least some of the excess material from the additively manufactured object. The method can further include moving the substrate to a plurality of different tilt angles relative to the frame during the rotation of the frame.

The embodiments described herein can provide improved cleaning of additively manufactured objects, particularly objects having complex geometries and/or that are fabricated using highly viscous materials that may otherwise be difficult to clean using conventional techniques. In conventional centrifuge systems, an object remains in a single fixed angle throughout cleaning, potentially resulting in ineffective cleaning of object surfaces that are sub- optimally positioned with respect to the applied centrifugal forces. In contrast, the present technology provides systems that move the object to a plurality of different tilt angles during centrifugation (also referred to herein as “multiangle centrifugation”), which can advantageously clean multiple surfaces of additively manufactured objects.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Overview of Additive Manufacturing Technology

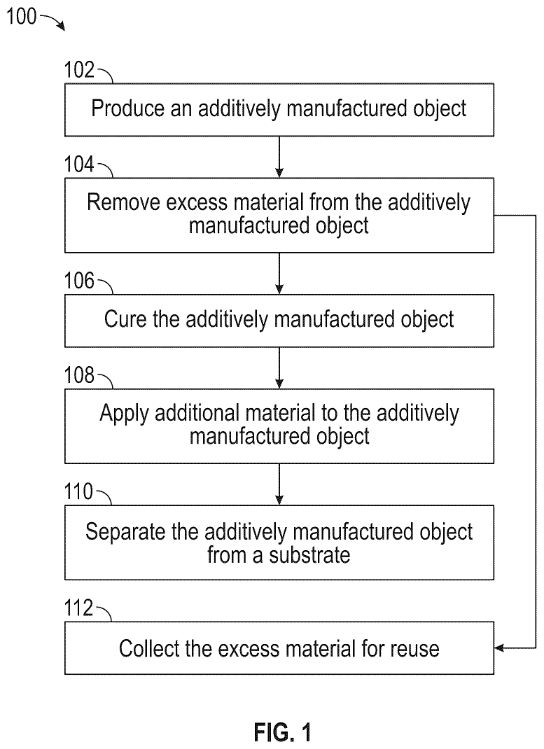

FIG. 1 is a flow diagram providing a general overview of a method 100 for fabricating and post-processing an additively manufactured object, in accordance with embodiments of the present technology. The method 100 can be used to produce many different types of additively manufactured objects, such as orthodontic appliances (e.g., aligners, palatal expanders, attachments, attachment templates, retainers), restorative objects (e.g., crowns, veneers, implants), and/or other dental appliances (e.g., oral sleep apnea appliances, mouth guards). Additional examples of dental appliances and associated methods that are applicable to the present technology are described in Section III below.

The method 100 begins at block 102 with producing an additively manufactured object. The additively manufactured object can be produced using any suitable additive manufacturing technique known to those of skill in the art. Additive manufacturing (also referred to herein as “3D printing”) includes a variety of technologies which fabricate 3D objects directly from digital models through an additive process. In some embodiments, additive manufacturing includes depositing a precursor material (e.g., a photopolymerizable resin) onto a build platform. The precursor material can be cured, polymerized, melted, sintered, fused, and/or otherwise solidified to form a portion of the object and/or combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high- temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,624 and U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Pat. No. 10,162,264 and U.S. Patent Publication No. 2014/0265034, the disclosures of which are incorporated herein by reference in their entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

After the additively manufactured object is fabricated, the object can undergo one or more additional process steps, also referred to herein as “post-processing.” As described in detail below with respect to blocks 104-112, post-processing can include removing excess material from the object, applying additional material(s) to the object, performing additional curing, separating the object from any supports or other structures that are not intended to be present in the final product, and/or collecting the removed excess material for reuse.

For example, at block 104, the method 100 continues with removing excess material from the additively manufactured object. The excess material can include uncured material (e.g., unpolymerized liquid resin) and/or other unwanted material (e.g., debris) that remains on the additively manufactured object after fabrication. For example, certain materials used in additive manufacturing (e.g., highly viscous polymeric resins used in high temperature lithography) may adhere to the surface of the additively manufactured object. Additionally, excess material may accumulate on or within certain object features, such as cavities, crevices, indentations, apertures, etc. Accordingly, the additively manufactured object may need to be cleaned before further processing and use.

The excess material can be removed in many different ways. In some embodiments, for example, the excess material is removed by rotating the additively manufactured object to centrifugally separate the excess material from the surfaces of the object. The rotation can be performed using a suitable device or system (e.g., a centrifuge) including components for supporting and applying rotational force to the additively manufactured object. Examples of systems, devices, and methods suitable for removing excess material from an additively manufactured object by rotation are described in detail in Section II below. Alternatively or in combination, the excess material can be removed by spraying or otherwise applying fluids (e.g., water, solvents) to the object, partially or fully immersing the object in a fluid, blowing a gas (e.g., air) on the object, applying a vacuum to the object, applying other types of mechanical forces to the object (e.g., vibration, agitation, tumbling, brushing), and/or other cleaning techniques known to those of skill in the art.

At block 106, the method 100 can optionally including curing the additively manufactured object. This additional curing step (also known as “post-curing”) can be used in situations where the additively manufactured object is still in a partially cured “green” state after fabrication. For example, the curing energy used to fabricate the additively manufactured object in block 102 may only partially polymerize the resin forming the object. Accordingly, the post-curing step may be needed to fully cure (e.g., fully polymerize) the additively manufactured object to its final, usable state. Post-curing can provide various benefits, such as improving the mechanical properties (e.g., stiffness, strength) and/or temperature stability of the additively manufactured object. Post-curing can be performed by heating the object, applying radiation (e.g., ultraviolet (UV), visible, microwave) to the object, or suitable combinations thereof. Post-curing can be performed by a specialized device (e.g., an oven or curing station) or can be performed by the same device used to rotate the additively manufactured object in block 104. In other embodiments, however, the post-curing process of block 106 is optional and can be omitted.

At block 108, the method 100 can optionally include applying an additional material to the additively manufactured object. For example, the additional material can be a coating, such as a polymeric coating. The coating can be applied to one or more surfaces of the object for various purposes, including, but not limited to: providing a smooth surface finish, which can be beneficial for aesthetics and/or to improve user comfort if the object is intended to be in contact with the user's body (e.g., an dental appliance worn on the teeth); coloring and/or applying other aesthetic features to the object; improving scratch resistance and/or other mechanical properties; providing antimicrobial properties; and incorporating therapeutic agents into the object for controlled release.

At block 110, the method 100 can include separating the additively manufactured object from a substrate. In some embodiments, the substrate is a build platform which mechanically supports the object during fabrication and the post-processing steps described herein. The additively manufactured object can be connected to the substrate via a sacrificial region of cured material. Accordingly, the additively manufactured object can be detached from the substrate by applying pressure to fracture the sacrificial region. Once separated, the additively manufactured object can then be prepared for packaging, shipment, and use.

At block 112, the method 100 can optionally include collecting the excess material removed from the additively manufactured object in block 104. The excess material can include uncured material that is still suitable for reuse in subsequent additive manufacturing processes (e.g., the fabrication process of block 102). Accordingly, block 112 can include collecting the excess material (e.g., via containers, absorbent elements, piping, etc.) and, optionally, separating reusable excess material from other unwanted components that may be present (e.g., water, solvents, debris) via filtration, distillation, centrifugation, and/or other suitable techniques.

The method 100 can be modified in many different ways. For example, although the above steps of the method 100 are described with respect to a single additively manufactured object, the method 100 can be used to concurrently fabricate and post-process any suitable number of additively manufactured objects, such as tens, hundreds, or thousands of additively manufactured objects. As another example, the ordering of the steps shown in FIG. I can be varied, e.g., the material application process of block 108 can be performed before the curing process of block 106. Some of the steps of the method 100 can be omitted, such as any of blocks 106, 108, and/or 112. The method 100 can also include additional steps not shown in FIG. 1.

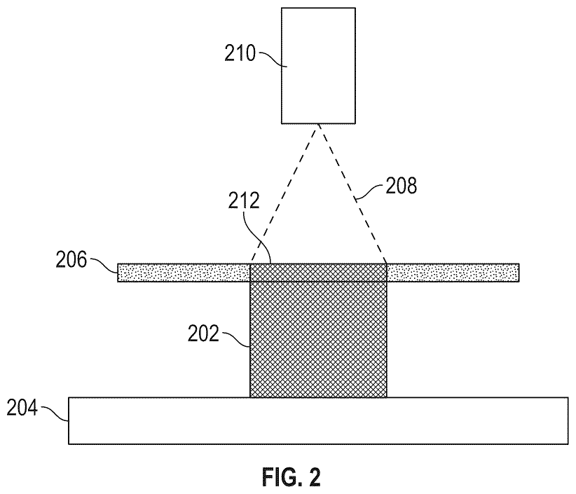

FIG. 2 is a partially schematic diagram providing a general overview of an additive manufacturing process, in accordance with embodiments of the present technology. In the embodiment of FIG. 2, an object 202 is fabricated on a build platform 204 from a series of cured material layers, with each layer having a geometry corresponding to a respective cross-section of the object 202. To fabricate an individual object layer, a layer of curable material 206 (e.g., polymerizable resin) is brought into contact with the build platform 204 (when fabricating the first layer of the object 202) or with the previously formed portion of the object 202 on the build platform 204 (when fabricating subsequent layers of the object 202). In some embodiments, the curable material 206 is formed on and supported by a substrate (not shown), such as a film. Energy 208 (e.g., light) from an energy source 210 (e.g., a laser, projector, or light engine) is then applied to the curable material 206 to form a cured material layer 212 on the build platform 204 or on the object 202. The remaining curable material 206 can then be moved away from the build platform 204 (e.g., by lowering the build platform 204, by moving the build platform 204 laterally, by raising the curable material 206, and/or by moving the curable material 206 laterally), thus leaving the cured material layer 212 in place on the build platform 204 and/or object 202. The fabrication process can then be repeated with a fresh layer of curable material 206 to build up the next layer of the object 202.

The illustrated embodiment shows a “top down” configuration in which the energy source 210 is positioned above and directs the energy 208 down toward the build platform 204, such that the object 202 is formed on the upper surface of the build platform 204. Accordingly, the build platform 204 can be incrementally lowered relative to the energy source 210 as successive layers of the object 202 are formed. In other embodiments, however, the additive manufacturing process of FIG. 2 can be performed using a “bottom up” configuration in which the energy source 210 is positioned below and directs the energy 208 up toward the build platform 204, such that the object 202 is formed on the lower surface of the build platform 204. Accordingly, the build platform 204 can be incrementally raised relative to the energy source 210 as successive layers of the object 202 are formed.

Although FIG. 2 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

### II. Removal of Material from Additively Manufactured Objects

The present technology provides systems, methods, and devices for removal of material from additively manufactured objects. As noted above, excess material may remain on object surfaces and/or accumulate within object features (e.g., cavities) after the additive manufacturing process. The excess material may cause unintentional structural, functional, and/or aesthetic changes to the object. For instance, the excess material may include uncured material that, if not removed, is cured during post-processing (e.g., post-curing) of the object and becomes incorporated into the object geometry, resulting in deviations from the desired object geometry, uneven surfaces, incidental protrusions, blemishes, etc. Centrifugation is a technique that can be used to remove excess material from additively manufactured objects. In centrifugation, the object is rotated at sufficiently high speeds for centrifugal forces to drive the excess material off the rest of the object. In some embodiments of the present technology, centrifugation is performed while the object is tilted at multiple angles, as will now be described in further detail.

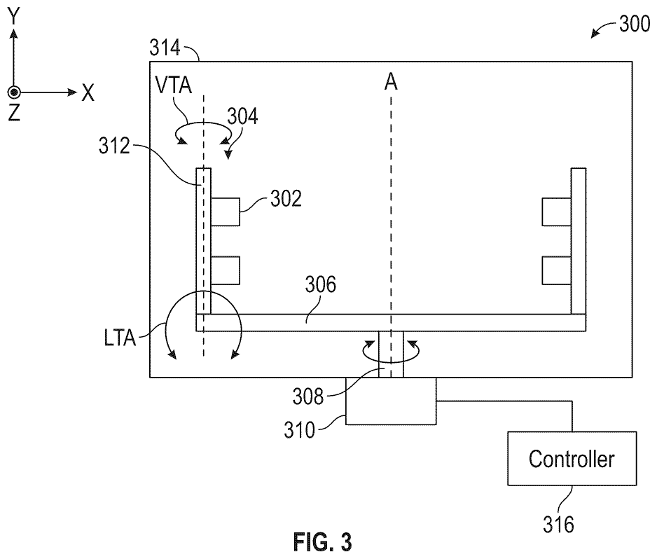

FIG. 3 is a partially schematic illustration of a system 300 for removing material from additively manufactured objects 302, in accordance with embodiments of the present technology. The system 300 includes a rotor 304 configured to support and rotate a set of additively manufactured objects 302. The rotor 304 includes a frame 306 (e.g., a plate, tray, one or more arms) coupled to a rotor shaft 308, and the rotor shaft 308 is coupled to an actuator 310 (e.g., a motor) that spins the frame 306 around a rotational axis A. The actuator 310 can spin the frame 306 in a clockwise direction, a counterclockwise direction, or both. The rotation of the frame 306 can produce forces that remove excess material by driving the material away from the center of rotation and off the surfaces of the objects 302. For example, the rotation can produce forces of at least 50 g, 100 g, 150 g, 200 g, 250 g, 300 g, 350 g, 400 g, 450 g, or 500 g; and/or within a range from 50 g to 100 g, or from 100 g to 200 g. The actuator 310 can be configured to rotate at any rotation speed suitable for producing the desired force, such as at least 50 RPM, 100 RPM, 200 RPM, 300 RPM, 400 RPM, 500 RPM, or more. Optionally, the system 300 may include one or more heating elements (not shown) to heat the objects 302 to an elevated temperature during the rotation of the frame 306 to lower the viscosity of the material to facilitate cleaning.

In the illustrated embodiment, the objects 302 are coupled to a substrate 312, and the substrate 312 is coupled to the frame 306 of the rotor 304. The substrate 312 can be the build platform used when fabricating the objects 302, can be another component (e.g., a separate plate, tray), or a combination thereof (e.g., the build platform mounted onto a base plate). The substrate 312 can be removably coupled to the frame 306 in any suitable manner, such as using fasteners (e.g., brackets, clamps, screws, clips), mating features (e.g., a peg on the substrate 312 that fits into a hole in the frame 306), snap fit, interference fit, magnets, adhesives, vacuum, etc. Although FIG. 3 depicts the substrate 312 as being coupled to the frame 306 via a direct connection, in other embodiments, the substrate 312 may be coupled to the frame 306 indirectly, e.g., the substrate 312 can be supported by a holder or other component that is directly connected to the frame 306.

Although FIG. 3 depicts the substrate 312 as being orthogonal to the frame 306, in other embodiments, the substrate 312 can alternatively be angled relative to the frame 306. Additionally, although the substrate 312 is illustrated as extending vertically upward from the frame 306, in other embodiments, the substrate 312 can extend vertically downward from the frame 306, can extend parallel to the frame 306, or any other suitable orientation. Moreover, although FIG. 3 shows the substrate 312 being mounted to the frame 306 so the objects 302 face inward toward the axis of rotation A, in other embodiments, the substrate 312 can be mounted so that the objects 302 face outward away from the axis of rotation A.

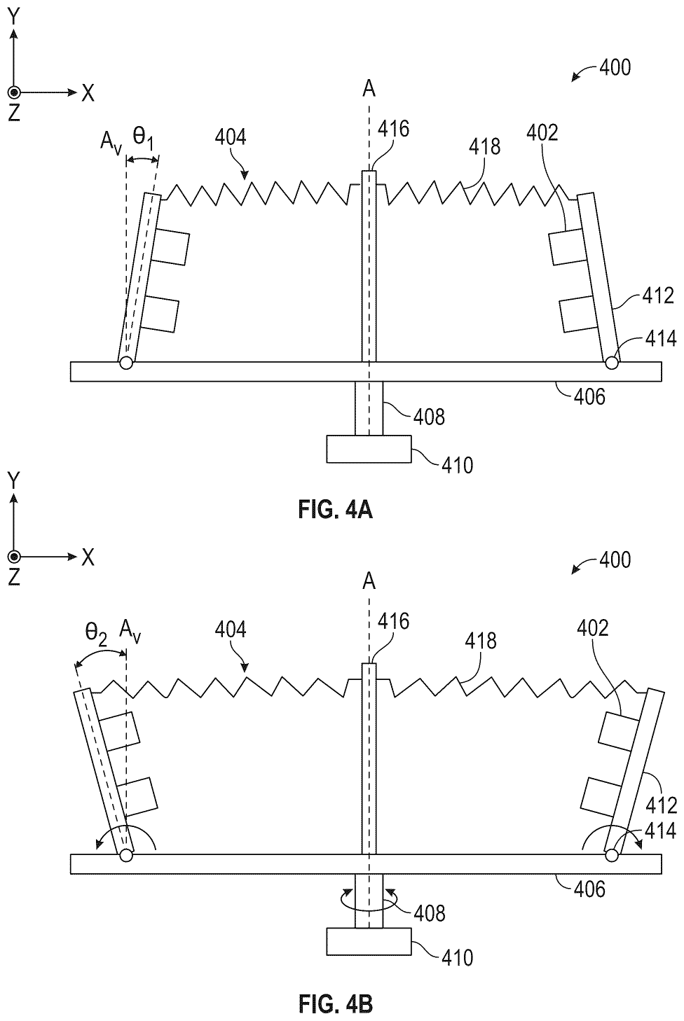

Optionally, the substrate 312 can be adjustable to many different positions and/or orientations (e.g., different tilt angles) relative to the frame 306 to vary the forces applied to the objects 302 to enhance material removal. For instance, the substrate 312 (and/or a holder supporting the substrate 312, if present) may be rotatable around a first axis of rotation (e.g., a lateral axis that is substantially orthogonal to the axis of rotation A, such as a Z-axis) and/or a second axis of rotation (e.g., a vertical axis that is substantially parallel to the axis of rotation A, such as a Y-axis) with respect to the frame 306. In some embodiments, the substrate 312 is rotatable to a plurality of different tilt angles, such as a plurality of different lateral tilt angles and/or a plurality of different vertical tilt angles. A “lateral tilt angle” refers an angle resulting from rotation of the substrate 312 around a lateral axis (e.g., an axis that is substantially orthogonal to the axis of rotation of A, such as the Z-axis), e.g., as indicated by arrow LTA. A “vertical tilt angle” refers an angle resulting from rotation of the substrate 312 around a vertical axis (e.g., an axis that is substantially parallel to the axis of rotation of A, such as the Y-axis), e.g., as indicated by arrow VTA. The movement of the substrate 312 may be effectuated using passive mechanisms (e.g., mechanisms that rely solely upon centrifugal forces and that do not use actuators that directly move the substrate 312), active mechanisms (e.g., using actuators to directly move the substrate 312), or a combination thereof. Additional details and examples of such mechanisms are described below in connection with FIGS. 4A-12B.

In the illustrated embodiment, the rotor 304 is enclosed in a housing 314. The housing 314 can provide an enclosed chamber so that the material removed from the objects 302 is contained and can be collected, e.g., for reuse or disposal. The housing 314 can also allow the environment surrounding the rotor 304 and objects 302 to be controlled, e.g., with respect to temperature, humidity, vacuum, air flow, radiation, etc. Although the actuator 310 is depicted as being located outside the housing 314, in other embodiments, the actuator 310 can instead be located within the housing 314.

In some embodiments, the system 300 includes a controller 316 for monitoring and/or controlling the operations of the rotor 304 (e.g., rotation speed, rotation direction, rotation duration). For instance, the controller 316 can be operably coupled to the actuator 310 to cause the actuator 310 to rotate the frame 306 at a plurality of different rotation speeds, where the plurality of different rotation speeds cause the substrate 312 to move to different tilt angles, as described in further detail below. Optionally, the controller 316 can monitor and/or control other functional components that may be present in the system 300, such as actuators to control the position and/or orientation of the substrate 312; sensors to monitor the position and/or orientation (e.g., tilt angle) of the substrate 312, cleaning status of the objects 302, environmental conditions within the housing 314; etc.

Additional examples of components and processes suitable for use with the system 300 are provided in U.S. Patent Publication No. 2023/0134234, the disclosure of which is incorporated by reference herein in its entirety.

The systems herein can be configured to adjust the tilt angle of the objects during rotation to alter the orientation of object surfaces relative to the direction of the centrifugal forces to enhance material removal. In some situations, centrifugal forces may be less effective in removing excess material from object surfaces that are substantially parallel to the axis of rotation. For instance, the centrifugal forces may be directed orthogonally outward relative to the axis of rotation, and thus may be imparted orthogonally onto an object surface that is parallel to the axis of rotation, thus pushing excess material against the surface rather than off the surface. Accordingly, it may be advantageous to adjust the relative angle of the object with respect to the axis of rotation so that most or all of the object surfaces are angled relative to the axis of rotation at some point during the centrifugation process, thereby improving material removal.

FIGS. 4A and 4B illustrate a system 400 for removing material from additively manufactured objects 402, in accordance with embodiments of the present technology. Specifically, FIG. 4A is a partially schematic side view of the system 400 at a first tilt angle, and FIG. 4B is a partially schematic side view of the system 400 at a second tilt angle. The system 400 can be generally similar to the system 300 of FIG. 3 and can include any of the components described in connection with the system 300 (certain components such as a housing and controller have been omitted in FIGS. 4A and 4B for simplicity). For instance, the system 400 can include a rotor 404 configured to support and rotate the set of additively manufactured objects 402. The rotor 404 can include a frame 406, rotor shaft 408, and an actuator 410 that spins the frame 406 around a rotational axis A. The actuator 410 can spin the frame 406 in a clockwise direction, a counterclockwise direction, or both. The rotation of the frame 406 can produce forces that remove excess material by driving the material away from the center of rotation and off the surfaces of the objects 402.

In some embodiments, the objects 402 are coupled to a substrate 412, and the substrate 412 is coupled to the frame 406 of the rotor 404. The substrate 412 can be coupled to the frame 406 via a rotatable coupling mechanism 414. The rotatable coupling mechanism 414 can include a hinge joint, cylindrical joint, ball joint, sliding joint, etc. The rotatable coupling mechanism 414 can allow the substrate 412 to rotate to a plurality of different tilt angles relative to the frame 406. The plurality of different tilt angles can be or include a plurality of lateral tilt angles resulting from rotation of the substrate 412 about a lateral axis (e.g., the Z-axis). The lateral tilt angle may be measured relative to the plane of the substrate 412 when the substrate 412 is in a vertical position parallel to the axis of rotation A, as represented by axis Aᵥ in FIGS. 4A and 4B (a lateral tilt angle of 0 degrees corresponds to the substrate 412 being in a vertical position). As shown in FIG. 4A, the substrate 412 may be rotated around the Z-axis in an inward direction (toward the axis of rotation A) by a first lateral tilt angle θ₁, where θ₁ is within a range from 0 degrees to 15 degrees, from 15 degrees to 30 degrees, from 30 degrees to 45 degrees, from 45 degrees to 60 degrees, from 60 degrees to 75 degrees, or from 75 degrees to 90 degrees. Conversely, as shown in FIG. 4B, the substrate 412 may be rotated around the Z-axis in an outward direction (away from the axis of rotation A) by a second lateral tilt angle θ₂, where θ₂ is within a range from 0 degrees to 15 degrees, from 15 degrees to 30 degrees, from 30 degrees to 45 degrees, from 45 degrees to 60 degrees, from 60 degrees to 75 degrees, or from 75 degrees to 90 degrees.

In some embodiments, the system 400 further includes a support 416 (e.g., a shaft, post, rod, strut, plate) coupled to the frame 406 and a spring element 418 coupled to the support 416. The support 416 can extend along (e.g., intersect, be collinear and/or concentric with) the axis of rotation A of the frame 406, or may be offset outward away from the axis of rotation A. In some embodiments, the support 416 is cylindrical. However, the support 416 can also be rectangular or have any other suitable geometry. Further, while the support 416 is illustrated as being substantially vertical, the support 416 may alternatively be angled relative to the axis of rotation A. In some embodiments, the support 416 is configured to be stable during rotation of the rotor 404. Stated differently, the support 416 may remain in a fixed position and orientation relative to the frame 406 during rotation. In some embodiments, the spring element 418 is coupled to the support 416 at an upper portion of the support 416. However, the spring element 418 may alternatively or additionally be coupled to the support 416 at a variety of other locations, such as at lower and/or lateral portions of the support 416.

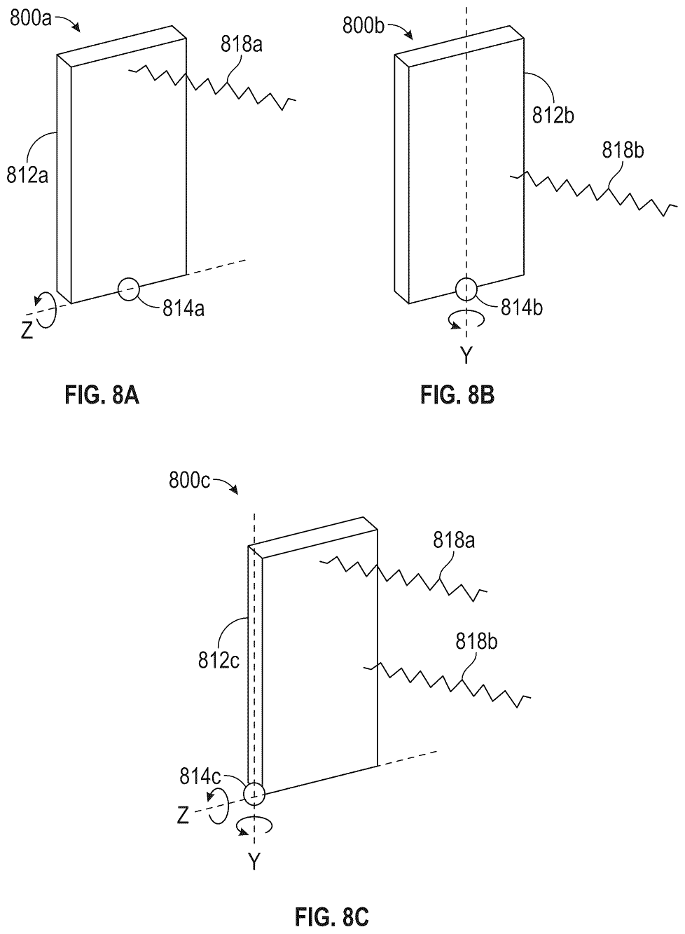

The spring element 418 can be any component that is capable of changing in length (e.g., extending and/or contracting) in response to centrifugal forces applied to the substrate 412 during the rotation of the frame 406. For example, the spring element 418 may be composed of one or more springs and/or dampers (the spring element 418 is illustrated as a single spring in FIGS. 4A and 4B merely for purposes of simplicity). The springs and/or dampers of the spring element 418 may be connected to each other in series, in parallel, or suitable combinations thereof. Further, a plurality of spring elements 418 may be used, as will be described later in connection with FIGS. 8A-8C.

The change in length of the spring element 418 can be configured to adjust an angle of the substrate 412 relative to the frame 406 during the rotation of the frame 406. The spring element 418 may be movable between a resting (e.g., unloaded) length and an extended length. For instance, the spring element 418 may have a first configuration in which the spring element 418 is at its resting length and the substrate 412 is tilted inward at a first lateral tilt angle θ₁. The first lateral tilt angle can be at least 10 degrees, at least 20 degrees, at least 30 degrees, at least 40degrees, at least 50 degrees, at least 60 degrees, at least 70 degrees, at least 80 degrees, or at least 90 degrees. Alternatively, the first lateral tilt angle can be about 0 degrees, such that the substrate 412 is substantially vertical.

Referring now to FIG. 4B, the spring clement 418 is shown in a second configuration in which the spring element 418 reaches its extended length and the substrate 412 is tilted outward at a second lateral tilt angle θ₂. The second lateral tilt angle can be at least 10 degrees, at least 20 degrees, at least 30 degrees, at least 40 degrees, at least 50 degrees, at least 60 degrees, at least 70 degrees, at least 80 degrees, or at least 90 degrees. Alternatively, the second lateral tilt angle can be about 0 degrees, such that the substrate 412 is substantially vertical.

Although FIGS. 4A and 4B illustrate the substrate 412 being at an inward lateral tilt angle when the spring element 418 is at its resting length and being at an outward lateral tilt angle when the spring element 418 is at its extended length, other configurations are also possible. For instance, the substrate 412 may move from a greater inward lateral tilt angle to a smaller inward lateral tilt angle, or vice versa. Alternatively or in addition, the substrate 412 may move from an inward lateral tilt angle to a vertical position (e.g., a lateral tilt angle of 0 degrees), or vice versa. Alternatively or in addition, the substrate 412 may move from a vertical position (e.g., a lateral tilt angle of 0 degrees) to an outward lateral tilt angle, or vice versa. Further, the substrate 412 may move from a smaller outward tilt angle to a larger outward tilt angle, or vice versa.

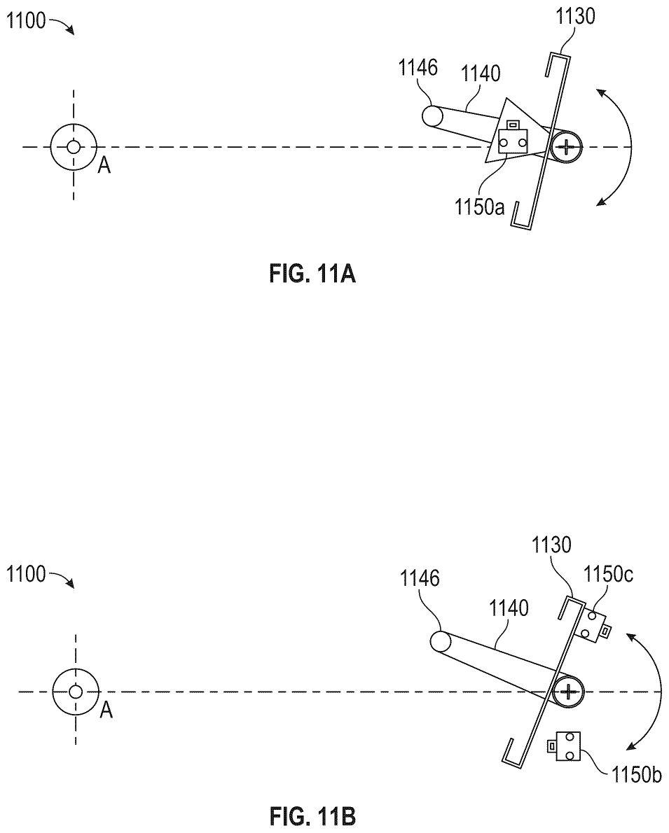

The spring element 418 may adjust the angle of the substrate 412 relative to the frame 406 passively. For instance, the spring element 418 may transition between the resting length and extended length primarily or solely in response to centrifugal forces produced by the rotation of the frame 406, thus allowing the angle of the substrate 412 to be adjusted without any actuators or other active elements that directly change the angle of the substrate 412. In some embodiments, this passive adjustment mechanism can advantageously reduce the complexity of the system, such as by omitting actuators that could get clogged with excess material and/or may be damaged by high rotation speeds. However, in other embodiments, one or more actuators may be configured to actively drive tilting of the substrate 412 in combination with the spring element 418, e.g., as described further below with respect to FIGS. 12A and 12B. Optionally, the spring element 418 may include or be coupled to one or more actuators (e.g., linear actuators) that actively drive the change in length of the spring element 418 to tilt the substrate 412.

In some embodiments, the spring element 418 transitions from the first configuration (e.g., resting length) to the second configuration (e.g., extended length) when the rotation speed of the frame 406 is increased via the rotor 404 (e.g., increasing activation of the actuator 410). For instance, the increasing rotation speed can increase the amount of centrifugal force applied on the substrate 412. When the amount of centrifugal force exceeds the spring force of the spring element 418, the substrate 412 tilts outwardly, thereby stretching (e.g., extending) the spring element 418. This causes the spring force of the spring element 418 to increase (e.g., as a result of the extension of the spring element 418), and the outward tilting of the substrate 412 stops when the spring element 418 has extended to a length such that the spring force of the spring element 418 is now equal to the centrifugal force.

Conversely, the spring element 418 can transition from the second configuration (e.g., extended length) to the first configuration (e.g., resting length) when the rotation speed of the frame 406 is decreased via the rotor 404 (e.g., decreasing activation of the actuator 410). For instance, the decreasing rotation speed can decrease the amount of centrifugal force applied on the substrate 412. When the amount of centrifugal force falls below the spring force of the spring clement 418, the substrate 412 tilts inwardly, thereby relaxing (e.g., contracting) the spring element 418. This causes the spring force of the spring element 418 to decrease (e.g., as a result of the contraction of the spring element 418), and the inward tilting of the substrate 412 stops when the spring element 418 has contracted to a length such that the spring force of the spring element 418 is now equal to the centrifugal force.

As the substrate 412 is tilted with respect to the frame 406, one or more surfaces of the objects 402 may become offset from the axis of rotation A, e.g., object surfaces that were previously parallel to the axis of rotation A are no longer parallel to the axis of rotation A. As a result, cleaning of the object surfaces can be improved since the applied centrifugal force is no longer orthogonal to the surfaces and thus can direct at least some of the material off the surface.

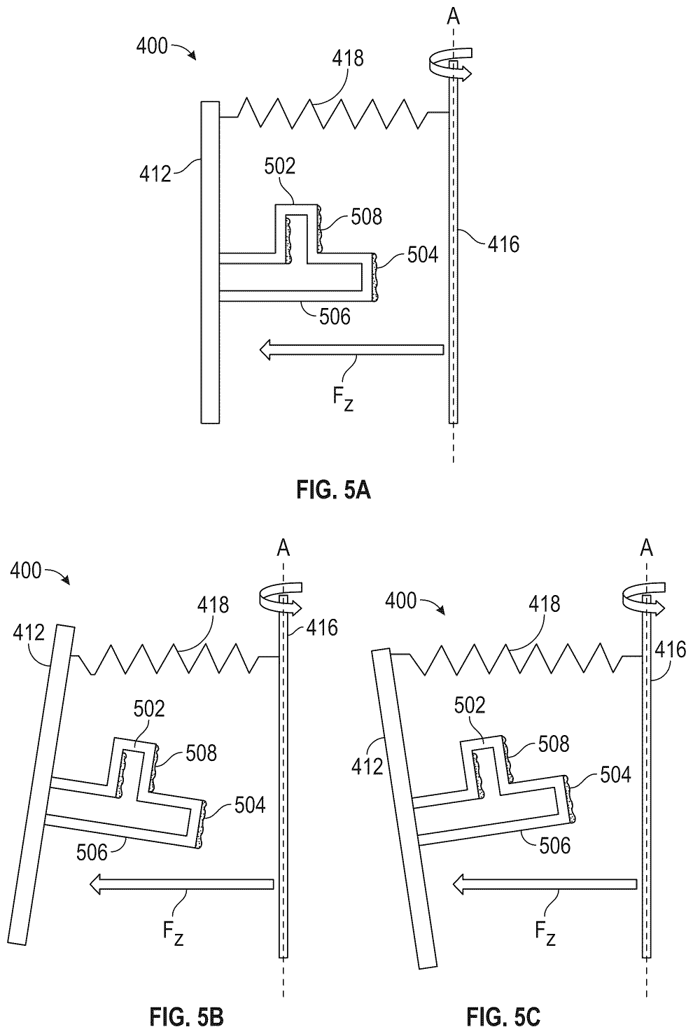

FIGS. 5A-5C illustrate the system 400 of FIGS. 4A and 4B in varying configurations, in accordance with embodiments of the present technology. Specifically, FIG. 5A is a partially schematic illustration of the system 400 where the substrate 412 is in a vertical position (lateral tilt angle of 0 degrees), FIG. 5B is a partially schematic illustration of the system 400 where the substrate 412 is rotated inward (inward lateral tilt angle), and FIG. 5C is a partially schematic illustration of the system 400 where the substrate 412 is rotated outward (outward lateral tilt angle). Referring to FIGS. 5A-5C together, the system 400 can be configured to rotate an additively manufactured object 502 (only one object 502 is illustrated for simplicity; a plurality of objects 502 may be carried by the system 400). The object 502 may include surfaces at different orientation relative to the axis of rotation A, such as a plurality of vertical object surfaces 504 and a plurality of horizontal object surfaces 506. As shown, excess material 508 may remain on at least some of the object surfaces, such as the plurality of vertical object surfaces 504.

Turning now to FIG. 5A, the substrate 412 is shown as being substantially parallel to the axis of rotation A. In this configuration, the vertical object surfaces 504 are substantially parallel to the axis of rotation A. As previously noted, it may be difficult to remove the excess material 508 from the vertical object surfaces 504 since centrifugal forces F_{Z} applied by the system 400 may impart forces orthogonally against the vertical object surfaces 504, pushing the excess material 508 against the vertical object surfaces 504 rather than away from the vertical object surfaces 504. However, this configuration may be effective in removing excess material 508 from other object surfaces, such as the horizontal object surfaces 506.

Turning now to FIG. 5B, the substrate 412 is shown as being angled toward the axis of rotation A. In this configuration, the vertical object surfaces 504 are angled downwardly toward the axis of rotation A. Compared with the configuration of FIG. 5A, the excess material 508 may be more easily removed from the vertical object surfaces 504 since the centrifugal forces F_{Z} are no longer orthogonally applied to the vertical object surfaces 504.

Turning now to FIG. 5C, the substrate 412 is shown as being angled away from the axis of rotation A. In this configuration, the vertical object surfaces 504 are angled upwardly toward the axis of rotation A. Compared with the configuration of FIG. 5A, the excess material 508 may be more easily removed from the vertical object surfaces 504 since the centrifugal forces F_{Z} are no longer orthogonally applied to the vertical object surfaces 504.

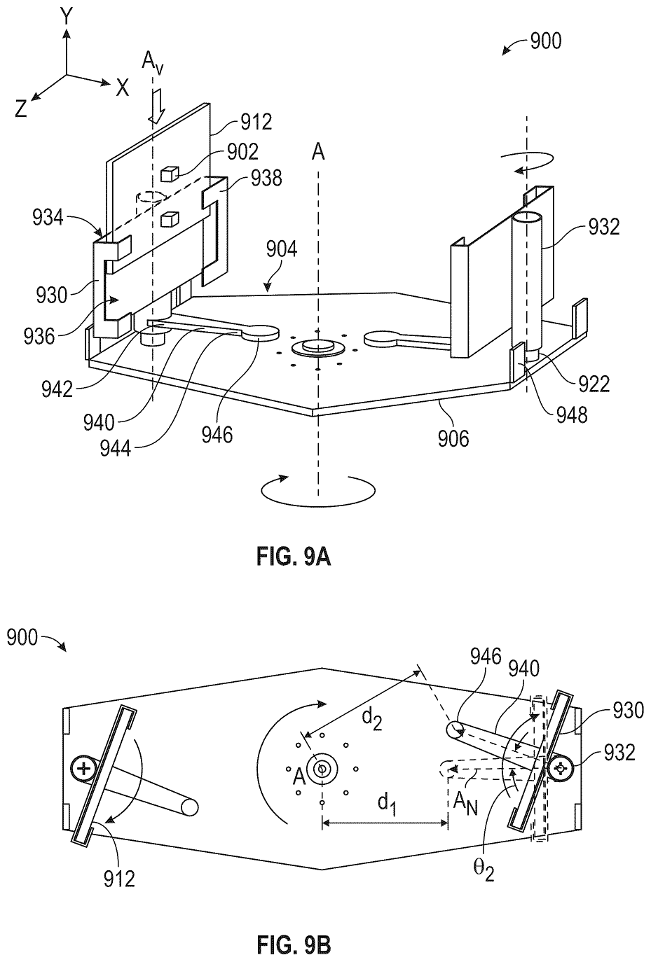

Referring again to FIGS. 4A and 4B, the amount of tilting of the substrate 412 can vary with the centrifugal force and/or rotation speed, e.g., larger forces and/or faster speeds can produce larger displacements of the substrate 412. However, in some embodiments, the range of tilt angles achievable via by the substrate 412 may be constrained by the spring clement 418 (e.g., via the maximum and/or minimum length of the spring element 418) and/or the rotatable coupling mechanism 414. For instance, the spring element 418 and/or the rotatable coupling mechanism 414 may constrain the substrate 412 to a predetermined angular range. In some embodiments, the first lateral tilt angle θ₁ and/or the second lateral tilt angle θ₂ are each independently constrained to be no greater than 10 degrees, 20 degrees, 30 degrees, 40 degrees, 50 degrees, 60 degrees, 70 degrees, 80 degrees, or 90 degrees. Optionally, one or more stoppers (not shown) can be used to limit rotation of the substrate 412. For instance, a stopper can be positioned on the frame 406 to prevent rotation of the substrate 412 beyond a desired angle. Suitable stoppers will be described later herein in connection with FIGS. 9A and 9B.

The operational parameters of the system 400 (e.g., centrifugal forces, rotation speed, rotation duration) can be selected to produce different positions and/or orientations of the substrate 412, thereby allowing for improved cleaning of different surfaces of the objects 402. For instance, the operational parameters can be set so that the substrate 412 is in a first position and/or orientation (e.g., the first lateral tilt angle θ₁) for a first period of time during the rotation, and then moves to a second position and/or orientation (e.g., the second lateral tilt angle θ₂) for a second period of time during the rotation, and so on. Further, although FIGS. 4A and 4B show the substrate 412 at two different tilt angles with respect to the frame 406, the substrate 412 may be moveable to a plurality of other tilt angles, e.g., three tilt angles, four tilt angles, etc.

The spring elements described herein (e.g., the spring element 418) can be designed to exhibit different responses to centrifugal forces generated by the rotation of the rotor, such as linear behavior (e.g., the change in the length of the spring element is linearly related to the amount of force) or non-linear behavior (e.g., the change in length of the spring element is nonlinearly related to amount of force). In some embodiments, the behavior of the spring element can affect the displacement (e.g., tilting) of the substrate during the rotation, which in turn may affect the removal of material from the objects carried by the substrate.

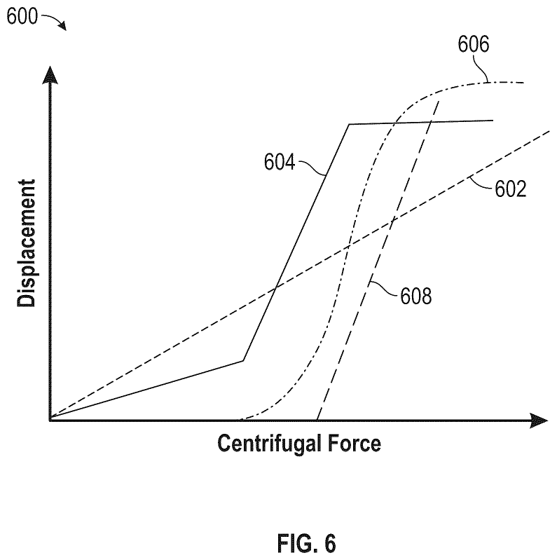

FIG. 6 depicts a graphical representation 600 of example force-displacement profiles achievable by the systems described herein, in accordance with embodiments of the present technology. As previously noted, a spring element can have a plurality of configurations which displace (e.g., tilt) the substrate relative to the axis of rotation A (e.g., laterally, vertically, or both). Further, the spring element may transition between the plurality of configurations in response to changing rotation speeds and/or centrifugal forces caused by the actuator, as discussed above. In the graphical representation 600, the X-axis indicates an amount of centrifugal force (increasing from left to right), and the Y-axis indicates an amount of displacement of the substrate relative to the axis of rotation A (increasing from bottom to top).

In general, as centrifugal force increases, the displacement of the substrate increases due to extension of the spring element 418. However, the behavior can be dependent on the properties of the spring element. For instance, force-displacement profile 602 represents a linear force-displacement response, where displacement (e.g., tilt angle) of the substrate increases linearly with centrifugal force applied to the substrate. Force-displacement profile 604 represents a multiphasic force-displacement response including (1) a first phase in which low centrifugal forces and/or rotation speeds result in little or no displacement of the substrate (e.g., the substrate remains at a first tilt angle), (2) a second phase in which intermediate centrifugal forces and/or rotation speeds result in a large displacement of the substrate (e.g., the substrates moves from a first tilt angle to a second tilt angle), and (3) a third phase in which high centrifugal forces and/or rotation speeds result in little or no displacement of the substrate (e.g., the substrate remains at the second tilt angle). As another example, force-displacement profile 606 shows an S-shaped (e.g., non-linear) response that is generally similar to the force-displacement profile 604, except with smooth transitions between the different phases. As a further example, force-displacement profile 608 shows that displacement of the substrate does not occur until a large centrifugal force is applied, at which point displacement increases linearly with centrifugal force. As can be seen in the graphical representation 600, many force-displacement profiles can be used with the systems described herein. In some embodiments, a force-displacement profile with steeper slopes and/or sharper inflection points provides for faster transitions between phases (and thereby tilt angles). For instance, a sharp transition between phases of a force-displacement profile may allow the substrate to rotate rapidly from a first tilt angle to a second tilt angle, e.g., when a threshold centrifugal force and/or rotation speed is met. In contrast, a smoother transition between phases may result in a more gradual shift from the first tilt angle to the second tilt angle. In some embodiments, this behavior can be tuned to rapidly switch between a plurality of tilt angles and/or to limit the number of tilt angles.

In some embodiments, the systems for removing material from additively manufactured objects described herein can additionally or alternatively include a guide structure (also known as a “guiding system”). The guide structure may be used in combination with a spring clement, such as the spring element 418 of FIGS. 4A-5C, to influence and/or limit the movement of a substrate during rotation.

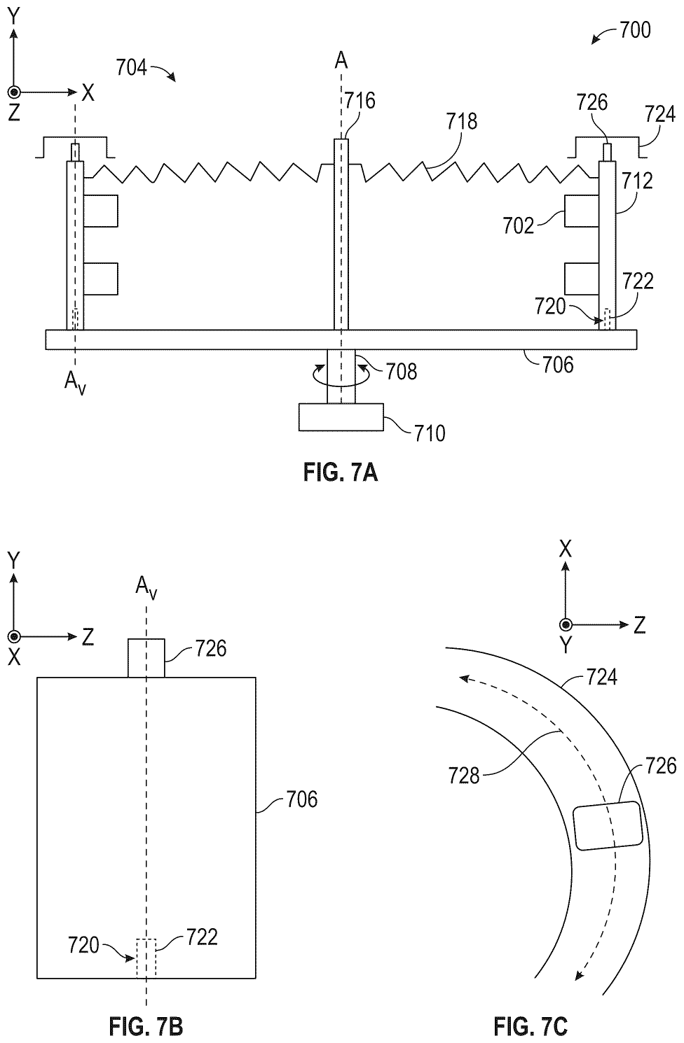

FIGS. 7A-7C illustrate a system 700 for removing material from additively manufactured objects 702, in accordance with embodiments of the present technology. Specifically, FIG. 7A is a partially schematic side view of the system 700, FIG. 7B is a close-up view of a substrate 712 of the system 700, and FIG. 7C is another close-up view of a guide structure 724 of the system 700. The system 700 can be generally similar to the system 400 of FIGS. 4A and 4B and can include any of the components described in connection with the system 400 (certain components such as a housing and controller have been omitted in FIGS. 7A-7C for simplicity). For instance, referring first to FIG. 7A, the system 700 can include a rotor 704, frame 706, rotor shaft 708, and an actuator 710 that spins the frame 706 in a clockwise direction, a counterclockwise direction, or both. Further, the additively manufactured objects 702 can be mounted on a substrate 712. The system 700 may further include a support 716 coupled to the frame 706 and a spring element 718 coupled to the support 716 and the substrate 712.

In some embodiments, the substrate 712 is coupled to the frame 706 via a rotatable coupling mechanism that permits rotation of the substrate 712 around at least two axes of rotation, such as a lateral axis (e.g., the Z-axis) and a vertical axis (e.g., the Y-axis). For instance, the rotatable coupling mechanism can include a hole 720 formed in a bottom surface of the substrate 712. The hole 720 can receive a corresponding projection 722 (e.g., a pin) on another component of the system (e.g., the rotor 704 or frame 706), thereby allowing for movement of the substrate 712 with respect to the projection 722. For instance, the hole 720 can be sized greater than the projection 722 to permit rotation of the substrate 712 around both the lateral axis (e.g., the Z-axis) and the vertical axis (e.g., the Y-axis) without dislodgement of the substrate 712 from the frame 706 during centrifugation. Alternatively, the hole 720 can be positioned within the frame 406, and the projection 722 can extend from the substrate 712. Further, other types of dual-axis rotatable coupling are possible, such as pivotable fasteners.

The system 700 can further include a guide structure 724 that is configured to direct the movement of the substrate 712 during varying stages of centrifugation. The guide structure 724 can be a channel, groove, recess, indentation, etc., that is configured to receive a protrusion 726 (e.g., extruded feature) extending from the substrate 712 (e.g., an upper surface thereof). The guide structure 724 can be positioned at any suitable location relative to the substrate 712, such as the edges of the substrate 712, near the center of the substrate 712, or suitable combinations thereof, depending on the location of the protrusion 726.

Referring now to FIG. 7B, the protrusion 726 can be rectangular, cylindrical, or any other suitable geometry. For instance, the protrusion 726 can be a rectangular protrusion having a thickness less than or equal to the width of the substrate 712. Further, the protrusion 726 can have a suitable height and width to be received partially or entirely within the guide structure 724.

Referring now to FIG. 7C, the guide structure 724 can define a path 728 for the substrate 712 to traverse during centrifugation. The path 728 can be linear, non-linear (e.g., curved such as C-shaped, S-shaped), or a combination thereof. At varying stages of the centrifugation, the substrate 712 may be tilted by the spring element 718, as described elsewhere herein, and the guide structure 724 can direct and/or limit the movement of the substrate 712 along the path 728. For instance, the path 728 can provide a range of different positions and/or orientations of the protrusion 726 of the substrate 712, which in turn can allow the substrate 712 to move to a corresponding range of different positions and/or orientations relative to the frame 706. As shown, the path 728 may direct the substrate 712 to rotate around the Y-axis (e.g., to a plurality of different vertical tilt angles) as the substrate 712 rotates around the Z-axis (e.g., to a plurality of different lateral tilt angles). This can provide additional degrees of freedom of movement of the substrate 712, which can improve the removal of excess material on the additively manufactured objects 702.

In some embodiments, the guide structure 724 includes a plurality of sections, such as two, three, four, five, six, seven, eight, nine, ten, or more sections. For instance, the guide structure 724 may include a first section corresponding to a first range of centrifugal forces, and a second section corresponding to a second range of centrifugal forces greater than the first range of centrifugal forces. When the protrusion 726 of the substrate 712 is in the first section of the guide structure 724, the substrate 712 may be at a first tilt angle (e.g., vertical tilt angle and/or lateral tilt angle) with respect to the frame 406. However, when the protrusion 726 of the substrate 712 is in the second section of the guide structure 724, the substrate 712 may be at a second tilt angle (e.g., vertical tilt angle and/or lateral tilt angle) with respect to the frame 406, the second tilt angle being different from the first tilt angle. The protrusion 726 of the substrate 712 may advance from one section to another in accordance with the centrifugal forces of the system 700. For instance, the protrusion 726 may remain within the first section until the centrifugal forces are sufficiently high, at which point the protrusion 726 may advance from the first section to the second section. This may be facilitated by the geometry of the guide structure 724, e.g., the guide structure 724 may include curves, corners, inflection points, etc., between the sections that provide a predetermined level of resistance to the motion of the protrusion 726 and thus prevent the protrusion 726 from moving to the next section until a threshold centrifugal force has been reached.

The spring-based systems described herein (e.g., the systems 400 and 700 described above in connection with FIGS. 4A-7C) can be varied in many ways. For instance, a plurality of spring elements may be coupled to each substrate. In some embodiments, the spring elements include at least one, two, three, four, five, six, seven, eight, nine, ten, etc., spring elements. Optionally, the spring elements can be located in different positions than previously depicted. Further, the substrate need not be directly coupled to the spring element(s). As an example, the substrate may be coupled to a holder that is coupled to the spring element(s).

FIGS. 8A-8C are illustrative examples of spring-substrate assemblies, in accordance with embodiments of the present technology. Specifically, FIG. 8A is a partially schematic illustration of a spring-substrate assembly 800a that is rotatable to different lateral tilt angles, FIG. 8B is a partially schematic illustration of a spring-substrate assembly 800b that is rotatable to different vertical tilt angles, and FIG. 8C is a partially schematic illustration of a spring-substrate assembly 800c that is rotatable to different lateral and vertical tilt angles. Any of the embodiments of FIGS. 8A-8C can be combined with any of the other embodiments described herein (e.g., the systems of FIGS. 3-7C).

Referring first to FIG. 8A, the spring-substrate assembly 800a can include a substrate 812a, rotatable coupling mechanism 814a, and first spring element 818a. The rotatable coupling mechanism 814a can be on the opposite side of the substrate 812a as the first spring clement 818a, e.g., the rotatable coupling mechanism 814a is at or near the bottom edge of the substrate 812a and the first spring element 818a is at or near the upper edge of the substrate 812a. Further, although the rotatable coupling mechanism 814a is shown at or near the center of the bottom edge of the substrate 812a, the rotatable coupling mechanism 814a can alternatively be at other locations, such as at or near a bottom corner of the substrate 812a. The configuration of the spring-substrate assembly 800a can allow the substrate 812a to rotate to a plurality of lateral tilt angles around a lateral tilt axis, such as the Z-axis, as shown. This rotation may be caused at least in part by activation of the first spring element 818a. For instance, the first spring clement 818a can be compressed and/or extended (e.g., in response to centrifugal forces and/or via an actuator) to adjust the lateral tilt angle of the substrate 812a around the Z-axis.

Turning now to FIG. 8B, the spring-substrate assembly 800b can include a substrate 812b, rotatable coupling mechanism 814b, and second spring element 818b. The rotatable coupling mechanism 814b can be on an adjacent side of the substrate 812b as the second spring clement 818b, e.g., the rotatable coupling mechanism 814b is at or near the bottom edge of the substrate 812b and the second spring clement 818b is at or near a lateral edge of the substrate 812b. Further, although the rotatable coupling mechanism 814b is shown at or near the center of the bottom edge of the substrate 812b, the rotatable coupling mechanism 814b can alternatively be at other locations, such as at or near a bottom corner of the substrate 812b. The configuration of the spring-substrate assembly 800b can allow the substrate 812b to rotate to a plurality of vertical tilt angles around a vertical axis, such as the Y-axis, as shown. This rotation may be caused at least in part by activation of the second spring element 818b. For instance, the second spring element 818b can be contracted and/or extended (e.g., in response to centrifugal forces and/or via an actuator) to adjust the vertical tilt angle of the substrate 812b around the Y-axis.

Turning now to FIG. 8C, the spring-substrate assembly 800b can include a substrate 812c, rotatable coupling mechanism 814c, a first spring element 818a at or near the upper edge of the substrate 812c, and a second spring element 818b at or near a lateral edge of the substrate 812c. The rotatable coupling mechanism 814c can be positioned at or near a bottom corner of the substrate 812c at the opposite lateral edge to the second spring element 818b. In some embodiments, the rotatable coupling mechanism 814c can allow for the substrate 812c to tilt to a plurality of lateral tilt angles around a lateral axis (e.g., the Z-axis) and/or a to a plurality of vertical tilt angles around a vertical axis (e.g., the Y-axis). For instance, force can be applied to the substrate 812c by both the first spring element 818a and the second spring element 818b simultaneously and/or substantially simultaneously to adjust both the vertical and lateral tilt of the substrate 812c. Optionally, the forces applied by the first spring element 818a and second spring element 818b may be different from each other to control the vertical and lateral tilt of the substrate 812c. For instance, applying a greater force via the first spring element 818a than the second spring element 818b may result in a greater tilting about the Z-axis than the Y-axis, and applying a greater force via the second spring element 818b than the first spring element 818a may result in a greater tilting about the Y-axis than the Z-axis.

FIGS. 9A-9D illustrate a system 900 for removing material from additively manufactured objects 902, in accordance with embodiments of the present technology. Specifically, FIG. 9A is a partially schematic perspective view of the system 900, FIG. 9B is a partially schematic top view of the system 900, FIG. 9C is a partially schematic top view of a portion of the system 900 at a first tilt angle, and FIG. 9D is a partially schematic top view of the portion of the system 900 at a second tilt angle. The system 900 can be generally similar to the system 300 of FIG. 3 and can include any of the components described in connection with the system 300 (certain components such as the housing and controller have been omitted in FIGS. 9A-9D for simplicity). For instance, the system 900 can include a rotor 904 configured to support and rotate the set of additively manufactured objects 902 (the objects 902 are omitted in FIGS. 9B-9D for simplicity). The rotor 904 can include a frame 906, rotor shaft (not depicted), and an actuator (not depicted) that spins the frame 906 around a rotational axis A. The actuator can spin the frame 906 in a clockwise direction, a counterclockwise direction, or both. The rotation of the frame 906 can produce forces that remove excess material by driving the material away from the center of rotation and off the surfaces of the objects 902.

In some embodiments, the objects 902 are coupled to a substrate 912 (e.g., a build platform) and the substrate 912 is supported by a holder 930. In some embodiments, the holder 930 includes a slot 934, and the substrate 912 can be inserted into and/or removed from the holder 930 via the slot 934, as shown in FIG. 9A. The slot 934 can be sized to accommodate the substrate 912. For instance, the slot 934 can be a rectangular slot. However, the slot 934 may alternatively include other geometries such as circular, semicircular, conical, trapezoidal, etc., depending on the geometry of the substrate 912. The holder 930 may alternatively or additionally include one or more retention features 938 configured to retain the substrate 912 within the holder 930 during rotation. In some embodiments, the retention features 938 are or include tabs, pins, clips, projections, etc. Alternatively or in addition, the holder 930 may include other features and/or materials for retaining the substrate 912. For instance, the holder 930 may include adhesives, releasable coupling structures, locking mechanisms (e.g., mechanical or electromagnetic components), etc., for securing the substrate 912 during rotation.

The holder 930 can define one or more openings 936. Excess material can be flung off the objects 902 through the openings 936. In some embodiments, the openings 936 face the axis of rotation A. Alternatively or in combination, the openings 936 can face away from the axis of rotation A.

The holder 930 can be coupled to the frame 906 via a rotatable coupling mechanism to allow the holder 930 and substrate 912 to rotate to a plurality of different tilt angles relative to the frame 906. As shown in FIG. 9B, the plurality of different tilt angles can be or include a plurality of vertical tilt angles resulting from rotation of the holder 930 and substrate 912 about a vertical axis (e.g., the Y-axis). The vertical tilt angle may be measured relative to the normal vector to the plane of the substrate 912, as represented by the dashed arrows in FIG. 9B. For instance, a vertical tilt angle of 0 degrees occurs when the normal vector is orthogonal to the axis of rotation A (represented by A_{N} in FIG. 9B). The vertical tilt angle can be within a range from 0 degrees to 15 degrees, from 15 degrees to 30 degrees, from 30 degrees to 45 degrees, from 45 degrees to 60 degrees, from 60 degrees to 75 degrees, or from 75 degrees to 90 degrees, in a clockwise direction, a counterclockwise direction, or both.

In the illustrated embodiment, the holder 930 includes an elongate member 932 having a lumen configured to receive a corresponding projection 922 (e.g., a pin, column) on another component of the system (e.g., the rotor 904 or frame 906), thereby allowing for movement of the holder 930 with respect to the projection 922. For instance, the lumen of the elongate member 932 can have a greater diameter than the projection 922 to permit rotation of the holder 930 around the projection 922, e.g., the projection 922 serves as the center of rotation for the holder 930. In other embodiments, however, other types of rotatable couplings between the holder 930 and the frame 906 can be used.

In some embodiments, the holder 930 includes or is coupled to a counterweight assembly that controls the tilting of the holder 930 and substrate 912 during the rotation of the frame 806. For instance, as shown in FIG. 9A, the system 900 can further include an arm 940 coupled to the holder 930. In some embodiments, the arm 940 includes a first end 942 coupled to the holder 930 and a second end 944 extending inwardly toward the axis of rotation A. The second end 944 of the arm 940 can be coupled to a weight 946. In some embodiments, the weight 946 is solely supported by the arm 940, e.g., does not contact the frame 906. The weight 946 can be selected based on the weight of the objects 902, substrate 912, desired tilt sensitivities, and more.

Turning now to FIG. 9B, the holder 930 can be rotatable between a first configuration in which the weight 946 is positioned proximate to the axis of rotation A (e.g., there is a first separation distance d₁ between the weight 946 and the axis of rotation A) and a second configuration in which the weight 946 is positioned away from the axis of rotation A (e.g., there is a second, greater separation distance d₂ between the weight 946 and the axis of rotation A). When the holder 930 is in the first configuration (shown with dashed lines), the substrate 912 is positioned at a first tilt angle (e.g., depicted as 0 degrees in FIG. 9B) relative to the frame 906. When the holder 930 is in the second configuration (shown with solid lines), the substrate 912 is positioned at a second tilt angle θ₂ relative to the frame 906.

The holder 930 can transition between the first configuration and the second configuration in response to the rotation of the frame 906. For instance, the inertia of the holder 930 and substrate 912 to the rotation of the frame 906 may cause the holder 930 and substrate 912 to swivel clockwise, counterclockwise, or a combination thereof around the vertical axis relative to the frame 906, depending on the direction of rotation of the frame 906. When the holder 930 begins to swivel in one direction (e.g., clockwise) around the vertical axis, the weight 946 may be displaced from its initial position. The displacement of the weight 946 increases the torque affecting the holder 930, which may “lock” the holder 930 at the second tilt angle θ₂ (e.g., the holder 930 will not rotate back in the opposite direction) as long as the rotation speed of the frame 906 remains above a threshold.

Turning now to FIG. 9C, rotation of the rotor 904 can cause the holder 930 and attached arm 940 to swivel in one direction (e.g., clockwise) around the vertical axis. For instance, the rotation of the rotor 904 applies a centrifugal force F_{z} to the weight 946, where the centrifugal force F_{z} is defined as:

$${F}_{z} = m {ω}^{2} r$$

where m is the mass of the weight 946, ω is the centrifugal force applied to the weight 946, and r is the distance of the weight 946 from the axis of rotation A.

The centrifugal force F_{z} applied to the weight 946 causes the holder 930 and attached arm 940 to swivel clockwise with a first torque Tₜ₁. The first torque Tₜ₁ can be expressed as:

$${T}_{{t}_{1}} = {F}_{z} \times {d}_{3}$$

where d₃ represents a first perpendicular distance from the center of rotation of the holder 930 and the line of action of the centrifugal force F_{z} (also known as the moment arm).

Turning now to FIG. 9D, as the torque Tₜ₁ rotates the holder 930 and arm 940 around the vertical axis, the moment arm increases from the first perpendicular distance d₃ to a second perpendicular distance d₄. This results in a second torque Tₜ₂, expressed as follows:

$${T}_{{t}_{2}} = {F}_{z} \times {d}_{4}$$

Since the second perpendicular distance d₄ is greater than the first perpendicular distance d₃, the second torque Tₜ₂ is also greater than the first torque Tₜ₁. Accordingly, the holder 930 will continue to rotate around the vertical axis Aᵥ in the same direction.

In some embodiments, the rotation of the substrate 912 with respect to the frame 906 is passive, e.g., the rotation of the substrate 912 may be caused solely due to the centrifugal forces F_{z} applied by the rotor 904 to the weight 946, thus allowing the substrate 912 to be adjusted without any actuators or other active elements that directly change the angle of the substrate 912. However, in other embodiments, one or more actuators may be configured to actively drive tilting of the substrate 912 in combination with the passive movement of the weight 946, e.g., as described further below with respect to FIGS. 12A and 12B. Optionally, the holder 930 and/or weight 946 may include or be coupled to one or more actuators (e.g., linear actuators) that actively move the holder 930 and/or weight 946 clockwise, counterclockwise, or both to tilt the substrate 912.

Returning to FIG. 9A, the system 900 can further include at least one stopper 948 configured to constrain rotation (e.g., clockwise and/or counterclockwise rotation) of the holder 930 relative to the frame 906. In some embodiments, the stopper 948 projects from the frame 906. The stopper 948 can be positioned such that when the holder 930 rotates to a maximum permissible vertical tilt angle, the holder 930 contacts the stopper 948, and the stopper 948 prevents further rotation of the holder 930 in the given direction. For instance, the stopper 948 may be positioned relative to the holder 930 such that the holder 930 cannot exceed a maximum vertical tilt angle of 50 degrees, 60 degrees, 70 degrees, 80 degrees, 90 degrees, 100 degrees, etc., clockwise, counterclockwise, or both. The stopper 948 can be or include an elongate protruding member (e.g., a post, plate, pin, projection, flap). Alternatively, the stopper 948 can have any suitable geometry for stopping the substrate 912 from further rotation. In some embodiments, the system 900 includes two stoppers positioned to limit both clockwise and counterclockwise movement of the holder 930. However, in other embodiments, there may be a single stopper 948 to limit only clockwise movement of the holder 930 or only counterclockwise movement of the holder 930. The stopper 948 may be sufficiently rigid to withstand high torque.

In some embodiments, it may be desirable to confirm that the substrate has reached a certain tilt angle during centrifugation, particularly for passive systems (e.g., the systems of FIGS. 3-11B) that do not actively drive the substrate to the desired tilt angle. If the desired angles are not reached, then the cleaning may be less thorough than desired, and/or more centrifugation may be necessary. Accordingly, it may be advantageous to identify when a target tilt angle has been reached using a sensor, such as a tilt indicator. In some embodiments, the tilt indicator is a binary indicator (e.g., yes or no). Alternatively, the tilt indicator may be able to indicate the degree of tilt that has been reached (e.g., 30 degrees vs. 40 degrees). Various types of tilt indicators may be used, such as mechanical switches, electrical switches (e.g., slip rings), force gauges, strain gauges, potentiometers, gyroscope, accelerometers, etc.

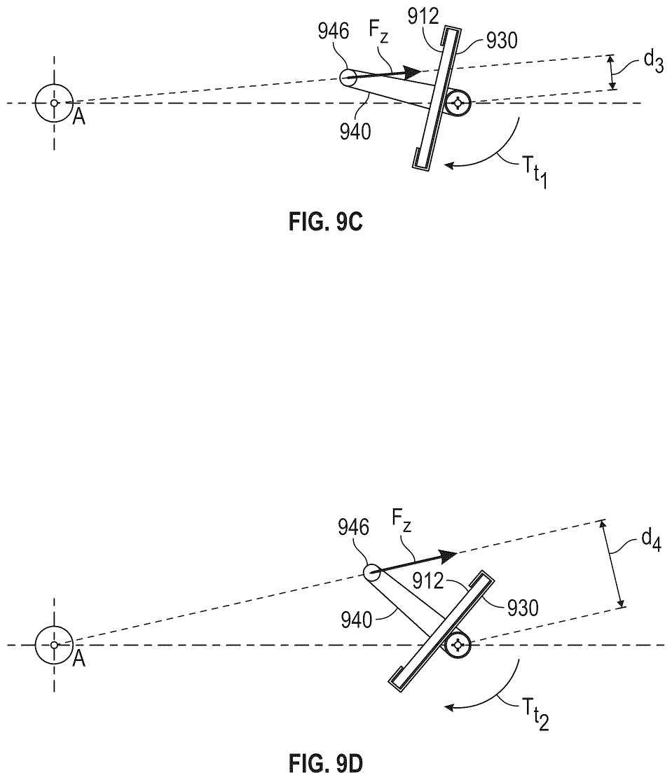

FIGS. 10A and 10B are partially schematic cross-sectional views of a tilt indicator 1050, in accordance with embodiments of the present technology. Referring to FIGS. 10A and 10B together, the tilt indicator 1050 can be configured to indicate whether a target tilt angle has been reached. In some embodiments, the tilt indicator 1050 is or includes a mechanical switch, such as a toggle switch. The tilt indicator 1050 can include an indicator panel 1052 constrained within a housing 1054. The housing 1054 can include an upper section 1056 and a lower section 1058. In some embodiments, the upper section 1056 and/or the lower section 1058 include a spring-loaded pin 1060. The spring-loaded pin 1060 may be configured to releasably secure the indicator panel 1052 to the housing 1054. For instance, the spring-loaded pin 1060 can be configured to engage one or more recesses 1062 of the indicator panel 1052.

The tilt indicator 1050 can be adjusted between a first configuration (FIG. 10A) and a second configuration (FIG. 10B). The tilt indicator 1050 can include a first indicator R and a second indicator L to differentiate between the first and second configurations. Referring now to FIG. 10A, the tilt indicator 1050 is shown in the first configuration. In the first configuration, the indicator panel 1052 is displaced rightward such that the first indicator R is positioned within the housing 1054 and the second indicator L is positioned outside of the housing 1054. Further, the spring-loaded pin 1060 can be engaged with a recess 1062 in the indicator panel 1052 proximate to the first indicator R to retain the tilt indicator 1050 in the first configuration. The tilt indicator 1050 can be placed in the first configuration before centrifugation begins.

The tilt indicator 1050 can be adjusted to the second configuration from the first configuration in response to a leftward force (e.g., in the direction LW) applied to the indicator panel 1052 via contact with the substrate (or a holder supporting the substrate). The force can cause the indicator panel 1052 to depress the spring-loaded pin 1060 so the indicator panel 1052 can slide leftward within the housing 1054. Turning now to FIG. 10B, the tilt indicator 1050 is shown in the second configuration. In the second configuration, the second indicator L is positioned within the housing 1054 and the first indicator R is positioned outside of the housing 1054. Further, the spring-loaded pin 1060 can be engaged with a recess 1062 in the indicator panel 1052 proximate to the second indicator L to retain the tilt indicator 1050 in the second configuration. Thus, if the tilt indicator 1050 is in the second configuration after centrifugation, this can provide confirmation that there was contact between the substrate (or holder) and the tilt indicator 1050, thus indicating that a desired tilt angle was reached.

In some embodiments, the tilt indicator 1050 may be operated in the opposite manner, e.g., the tilt indicator 1050 may be in the second configuration shown in FIG. 10B before centrifugation, and may be adjusted to the first configuration shown in FIG. 10A via a rightward force (e.g., in the direction RW) applied to the indicator panel 1052 via contact with the substrate (or a holder supporting the substrate). In some embodiments, the indication panel 1052 can include other indicators, such as other alphabetical indicators (e.g., “U” for an upward tilt), numerical indicators (e.g., “30°”), color gradients, shading gradients, etc.

The tilt indicator (e.g., the tilt indicator 1050 of FIGS. 10A and 10B) can be positioned in a variety of locations within the systems provided herein. In some embodiments, for example, the tilt indicator is located adjacent to a substrate (or a holder supporting the substrate) at a location corresponding to a desired tilt angle of the substrate. Alternatively or in combination, the tilt indicator can be located within a frame of a rotor, or any other suitable location.

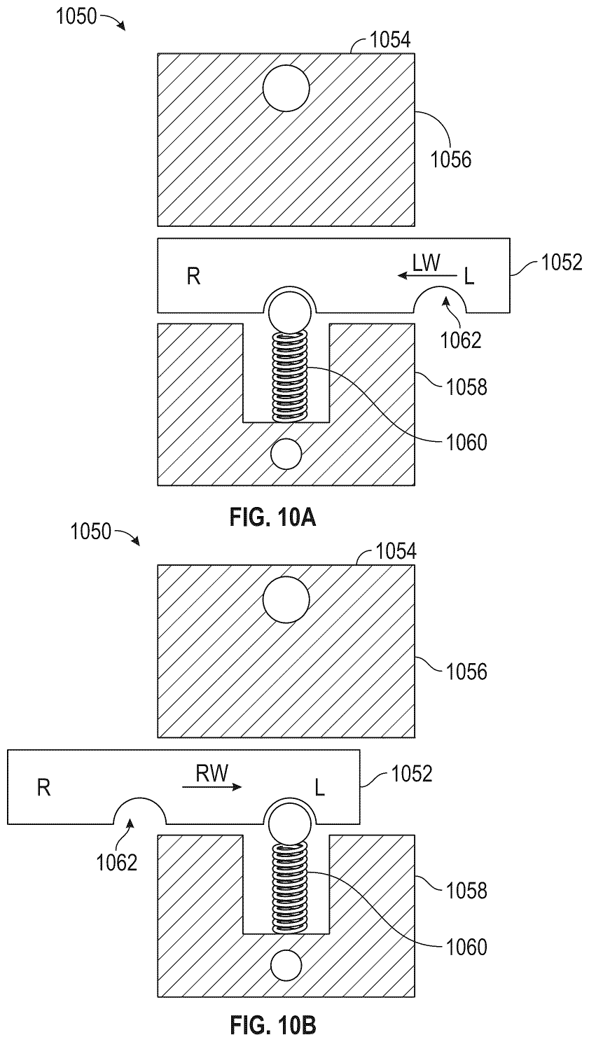

FIGS. 11A and 11B illustrate example portions of a system 1100 for removing material from an additively manufactured object (not shown), in accordance with embodiments of the present technology. Specifically, FIG. 11A is a partially schematic top view of an example portion of the system 1100 including a first tilt indicator 1150a, and FIG. 11B is a partially schematic top view of an example portion of the system 1100 including second and third tilt indicators 1150b and 1150c. The system 1100 can be generally similar to any of the systems and devices described herein, such as the system 900 of FIGS. 9A-9D. For instance, the system 1100 can include a rotor 1104 configured to support and rotate the additively manufactured object. The rotor 1104 can include a frame, rotor shaft, and an actuator that spins the frame around a rotational axis A (these components are omitted in FIGS. 11A and 11B for simplicity). The actuator can spin the frame in a clockwise direction, counterclockwise direction, or both. The rotation of the frame can produce forces that remove excess material by driving material away from the center of rotation and off the surfaces of the object.

In some embodiments, the object is coupled to a substrate (not shown), and the substrate is supported by a holder 1130. The holder 1130 can be pivotably coupled to the frame and can allow the substrate to rotate to a plurality of different tilt angles relative to the frame. For instance, the plurality of different tilt angles can be or include a plurality of vertical tilt angles resulting from rotation of the substrate about a vertical axis (e.g., the Y-axis). The holder 1130 can be coupled to an arm 1140 carrying a weight 1146.

Referring to FIG. 11A, in some embodiments, the first tilt indicator 1150a is positioned in between the axis of rotation A and the holder 1130. For instance, the first tilt indicator 1150a can be positioned below and/or above the arm 1140. The first tilt indicator 1150a can be moveable between a first configuration indicating a clockwise tilt and a second configuration indicating a counterclockwise tilt. The arm 1140 (or a component thereof) may be configured to press against the first tilt indicator 1150a from either side to transition the first tilt indicator 1150a from the first configuration to the second configuration, or vice versa. Alternatively, or in combination, the holder 1130 may be configured to press against the first tilt indicator 1150a. For instance, the holder may include both left and right projections for actuating the first tilt indicator 1150a.

Turning now to FIG. 11B, the system 1100 may additionally or alternatively include the second and third tilt indicators 1150b and 1150c. For instance, the second tilt indicator 1150b may be positioned on the frame (or housing) behind a left portion of the holder 1130. When the holder 1130 rotates counterclockwise, the second tilt indicator 1150b may switch from a first configuration to a second configuration indicating that a desired counterclockwise tilt angle has been reached. The third tilt indicator 1150c may be positioned on the frame (or other component of the system 1100) behind a right portion of the holder 1130. When the holder 1130 rotates clockwise, the third tilt indicator 1150c may switch from a first configuration to a second configuration indicating that a desired clockwise tilt angle has been reached.

Many other locations of the tilt indicator(s) are contemplated. For instance, the tilt indicator(s) may be positioned proximate to the weight 1146. Moreover, the tilt indicator(s) may also be used with any of the embodiments of the other systems described herein, such as the system 400 described in connection with FIGS. 4A-5C. For instance, the tilt indicator(s) may be used to measure a tilt angle of a substrate coupled to a spring element, such as the spring element 418 of the system 400 of FIGS. 4A-5C.

As previously noted, the systems described herein may include passive mechanisms, active mechanisms, or a combination thereof. In some embodiments, one or more actuators can be used to vary the tilt angle of a substrate carrying additively manufactured objects. The actuators may receive instructions from a controller (e.g., the controller 316 of the system 300 of FIG. 3). The actuators can be configured to tilt the substrate to vertical tilt angles, lateral tilt angles, or a combination thereof. Each actuator can move the respective portion of the substrate with respect to up to three degrees of freedom in translation (translation in X, Y, and/or Z) and/or with respect to up to three degrees of freedom in rotation (rotation around X, Y, and/or Z).

FIGS. 12A and 12B illustrate actuatable substrates 1212a and 1212b for use with systems of the present technology. The actuatable substrates 1212a and 1212b can be generally similar to the substrates described herein, such as the substrate 412 of the system 400 of FIG. 4. In some embodiments, the actuatable substrate 1212 is configured to carry a plurality of additively manufactured objects (not shown). The actuatable substrate 1212 can be adjusted to varying tilt angles while being rotated to remove material from the additively manufactured objects.

Referring first to FIG. 12A, the actuatable substrate 1212a can include a plurality of actuators 1264a (e.g., motors) positioned at one or more corners of the actuatable substrate 1212a. The actuators 1264a can be configured to tilt the actuatable substrate 1212a to a plurality of different tilt angles. The plurality of different tilt angles can include lateral tilt angles (e.g., rotation around a lateral axis, such as the Z-axis), vertical tilt angles (e.g., rotation around a vertical axis, such as the Y-axis), or both. Each actuator 1264a can independently control the respective corner of the actuatable substrate 1212a to translate along the X-axis, Y-axis, and/or Z-axis, and/or to rotate around the X-axis, Y-axis, and/or Z-axis.

Referring next to FIG. 12B, the actuatable substrate 1212b can be actuated by a plurality of actuators 1264b positioned along one or more edges of the actuatable substrate 1212b. The actuators 1264b can be configured to tilt the actuatable substrate 1212b to a plurality of different tilt angles. The plurality of different tilt angles can include lateral tilt angles (e.g., rotation around a lateral axis, such as the Z-axis), vertical tilt angles (e.g., rotation around a vertical axis, such as the Y-axis), or both. Each actuator 1264a can independently control the respective edge of the actuatable substrate 1212a to translate along the X-axis, Y-axis, and/or Z-axis, and/or to rotate around the X-axis, Y-axis, and/or Z-axis.

In some embodiments, the system 1200 further includes one or more sensors (e.g., tilt indicators), and the one or more sensors can provide signals to the controller for actuating the actuators 1264a and 1264b. For instance, a sensor can be positioned proximate to each of the actuators 1264a and 1264b, and a tilt angle of the actuatable substrate 1212a and/or actuatable substrate 1212b may be adjusted by providing feedback to the controller for adjusting the actuation of the actuators 1264a and 1264b. Alternatively or in combination, the actuators 1264a and 1264b may be adjusted by a user.

Although certain embodiments of the systems herein are depicted as supporting and rotating two substrates, this is not intended to be limiting, and the systems herein can be modified to support and rotate any number of substrates concurrently, such as three, four, five, six, or more substrates. The substrates may be arranged around the axis of rotation in a radially symmetric configuration to ensure that the system is balanced during centrifugation.

Moreover, any of the embodiments of the systems described herein may be combined with each other. For example, in some embodiments, a substrate is coupled to a spring clement (e.g., the spring element 418 of the system 400 of FIGS. 4A-4C) and is also supported by a holder carrying a weight (e.g., the weight 946 of the system 900 of FIGS. 9A-9D). The spring element can be capable of changing in length in response to centrifugal forces applied to the substrate during rotation. The spring element may be configured to adjust an angle of the substrate, such as by rotating the substrate to a plurality of lateral tilt angles. Further, the holder can be rotatable such that the substrate is tilted vertically. For instance, centrifugal forces applied to the weight can cause the substrate to rotate to a plurality of vertical tilt angles. Other combinations are contemplated. For instance, the substrate, spring element, and/or holder may further be coupled to one or more actuators for active tilting, as previously described.

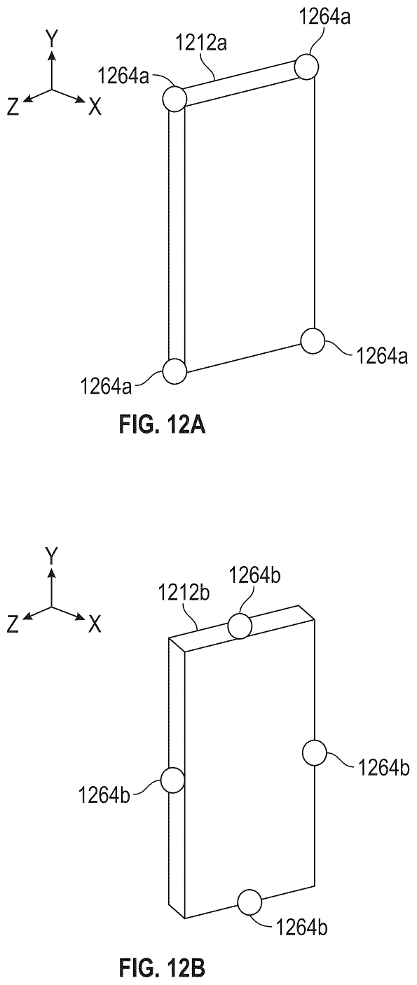

FIG. 13 is a flow diagram illustrating a method 1300 for post-processing an additively manufactured object, in accordance with embodiments of the present technology. The method 1300 can be performed by any of the systems and devices described herein, such as any of the embodiments of FIGS. 3-12B. In some embodiments, some or all of the processes of the method 1300 are implemented as computer-readable instructions (e.g., program code) that are configured to be executed by one or more processors of a computing device, such as a controller of an additive manufacturing system and/or a post-processing system. The method 1300 can be combined with any of the methods described herein, such as the method 100 of FIG. 1.

The method 1300 can begin at block 1302 with coupling a substrate carrying an additively manufactured object to a frame. The substrate can be a build platform (e.g., modular build platform) that is releasably coupled to the frame following an additive manufacturing process, such as the additive manufacturing processes described herein in connection with FIG. 2. In some embodiments, the substrate carries a plurality of additively manufactured objects (e.g., dental appliances). The substrate can be coupled to the carrier via a rotatable coupling mechanism. The rotatable coupling mechanism can include a hinge joint, cylindrical joint, ball joint, sliding joint, etc. The rotatable coupling mechanism can allow the substrate to rotate to a plurality of different tilt angles relative to the frame. Alternatively, the substrate can be coupled to the carrier via a releasable attachment technique, such as mechanical fixation (e.g., interference fit, snap fit, interlocking features, fasteners, form-fitting inserts, clamps, springs, hinged features), electromagnetic fixation, magnetic fixation, form-fitting inserts, or suitable combinations thereof. Optionally, the substrate may be supported by a holder, and the holder may be coupled to the frame using any of the aforementioned attachment techniques.

At block 1304, the method 1300 can continue with rotating the frame to remove excess material from the additively manufactured object. The excess material can include uncured material (e.g., unpolymerized liquid resin) and/or other unwanted material (e.g., debris) that remains on the additively manufactured object after fabrication. The rotation of the frame can apply centrifugal forces to the additively manufactured object to separate the excess material from the surfaces of the object. Optionally, removal of the excess material can be enhanced by heating the object, by spraying or otherwise applying fluids (e.g., water, solvents) to the object and/or other cleaning techniques known to those of skill in the art, e.g., as described in U.S. Patent Publication No. 2023/0134234, the disclosure of which is incorporated herein by reference in its entirety.

At block 1306, the method 1300 can continue with moving the substrate to a plurality of different tilt angles relative to the frame while the frame is rotated. In some embodiments, the plurality of different tilt angles includes a plurality of lateral tilt angles, a plurality of vertical tilt angles, or both. The substrate can be rotated at a plurality of different rotation speeds to cause the substrate to move to the plurality of different tilt angles. For instance, the frame can be rotated at a first rotation speed and a second rotation speed. The rotation of the frame at the first rotation speed may produce a first force that causes the substrate to move to a first tilt angle, and the rotation of the frame at the second rotation speed may produce a second force that causes the substrate to move to a second tilt angle, the second tilt angle being different from the first tilt angle.

The substrate can be moved to a plurality of different tilt angles passively, actively, or a combination thereof. For instance, in some embodiments, the substrate is moved between the plurality of different tilt angles using a spring element. The spring element can couple the substrate to the frame. At varying centrifugal forces effected by the rotation, the substrate can be tilted toward and/or away from the axis of rotation, causing a compression and/or extension of the spring length. The interaction between the centrifugal force and the spring force of the spring element may result in the substrate being suspended at the plurality of different tilt angles. For instance, the spring element may be at a resting length before the rotation of the frame, and the spring element may transition to an extended length during the rotation of the frame.

Alternatively or in combination, the substrate may be supported by a holder carrying a weight, and a location of the weight can change during the rotation of the frame to cause the substrate to move to a plurality of different tilt angles. For instance, the weight may cause the rotation force to apply a torque on the substrate that causes the substrate to rotate to the plurality of different tilt angles. The weight may be at a location proximate to the center of rotation of the frame before the rotation of the frame, and may move to a location away from the center of rotation of the frame during the rotation of the frame. Alternatively or in combination, the substrate may be coupled to one or more actuators configured to translate and/or rotate the substrate during the rotation.

At block 1308, the method 1300 can include measuring a tilt angle of the substrate. The tilt angle may be measured with respect to the frame. In some embodiments, the tilt angle is measured using one or more sensors, and the sensors may include one or more tilt indicators, such as mechanical switches, electrical switches, etc. For instance, the tilt indicators may include alphabetical, numerical, and/or symbolic indicators that are switched or otherwise actuated by the substrate and/or other components of the system during the rotation. The tilt indicators may be used to output an indication of whether the substrate achieved a target tilt angle during the rotation of the frame. Optionally, the tilt indicator may provide feedback for adjusting the operation of the system, e.g., if the desired tilt angle has not been reached after a desired time period, a human operator or an automated controller can increase the rotation speed of the frame and/or can repeat the rotation process. In other embodiments, however, the process of block 1308 is optional and may be omitted.

The method 1300 illustrated in FIG. 13 can be modified in many different ways. For example, the ordering of the processes shown in FIG. 13 can be varied. Some of the processes of the method 1300 can be omitted and/or the method 1300 can include additional processes not shown in FIG. 13. For instance, the method 1300 can further include adjusting the tilt angle of the substrate relative to the frame based on the measurement. Further, the method 1300 may include collecting excess material removed from the additively manufactured object for later reuse.

### III. Dental Appliances and Associated Methods

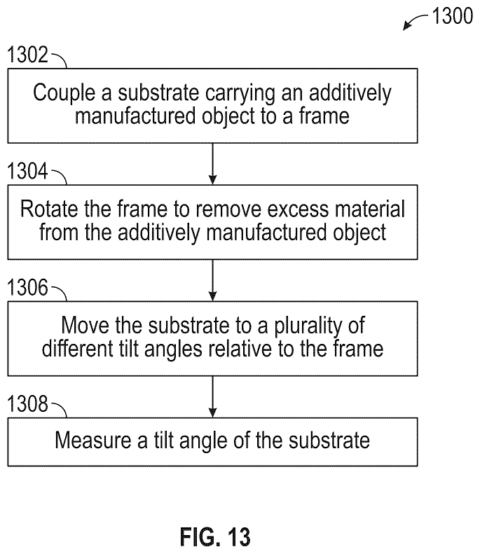

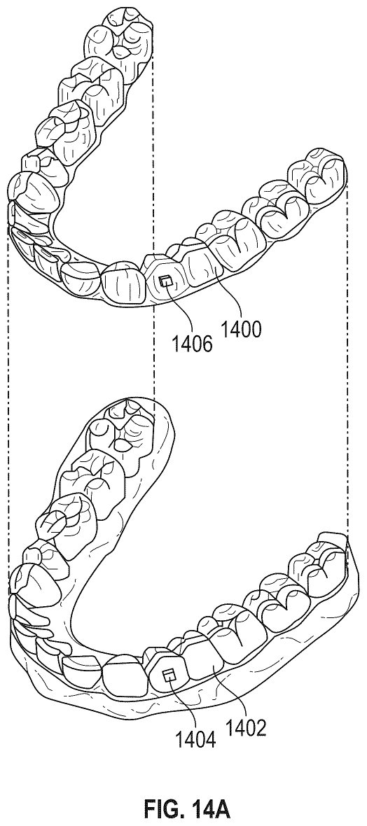

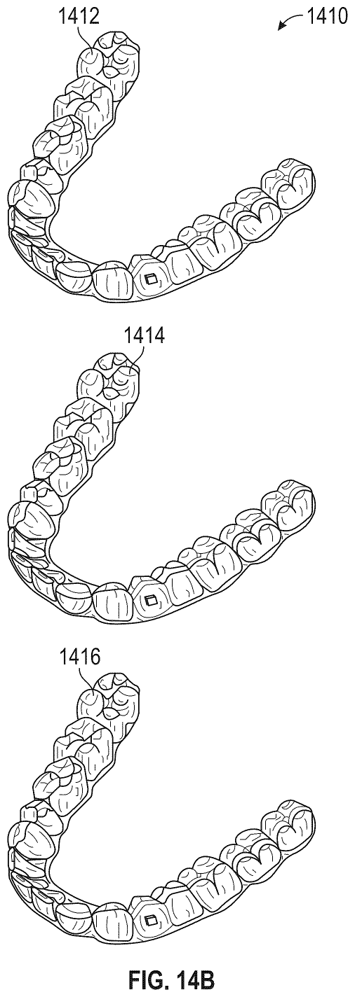

FIG. 14A illustrates a representative example of a tooth repositioning appliance 1400 configured in accordance with embodiments of the present technology. The appliance 1400 can be manufactured using any of the systems, methods, and devices described herein. The appliance 1400 (also referred to herein as an “aligner”) can be worn by a patient in order to achieve an incremental repositioning of individual teeth 1402 in the jaw. The appliance 1400 can include a shell (e.g., a continuous polymeric shell or a segmented shell) having teeth-receiving cavities that receive and resiliently reposition the teeth. The appliance 1400 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1400 can fit over all teeth present in an upper or lower jaw, or less than all of the teeth. The appliance 1400 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1400 can be a generic appliance configured to receive the teeth, but not necessarily shaped to match the topography of the patient's teeth. In some cases, only certain teeth received by the appliance 1400 are repositioned by the appliance 1400 while other teeth can provide a base or anchor region for holding the appliance 1400 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1400 in place over the teeth. In some cases, however, it may be desirable or necessary to provide individual attachments 1404 or other anchoring elements on teeth 1402 with corresponding receptacles 1406 or apertures in the appliance 1400 so that the appliance 1400 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 14B illustrates a tooth repositioning system 1410 including a plurality of appliances 1412, 1414, 1416, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1410 can include a first appliance 1412 corresponding to an initial tooth arrangement, one or more intermediate appliances 1414 corresponding to one or more intermediate arrangements, and a final appliance 1416 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 14C illustrates a method 1420 of orthodontic treatment using a plurality of appliances, in accordance with embodiments of the present technology. The method 1420 can be practiced using any of the appliances or appliance sets described herein. In block 1422, a first orthodontic appliance is applied to a patient's teeth in order to reposition the teeth from a first tooth arrangement to a second tooth arrangement. In block 1424, a second orthodontic appliance is applied to the patient's teeth in order to reposition the teeth from the second tooth arrangement to a third tooth arrangement. The method 1420 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

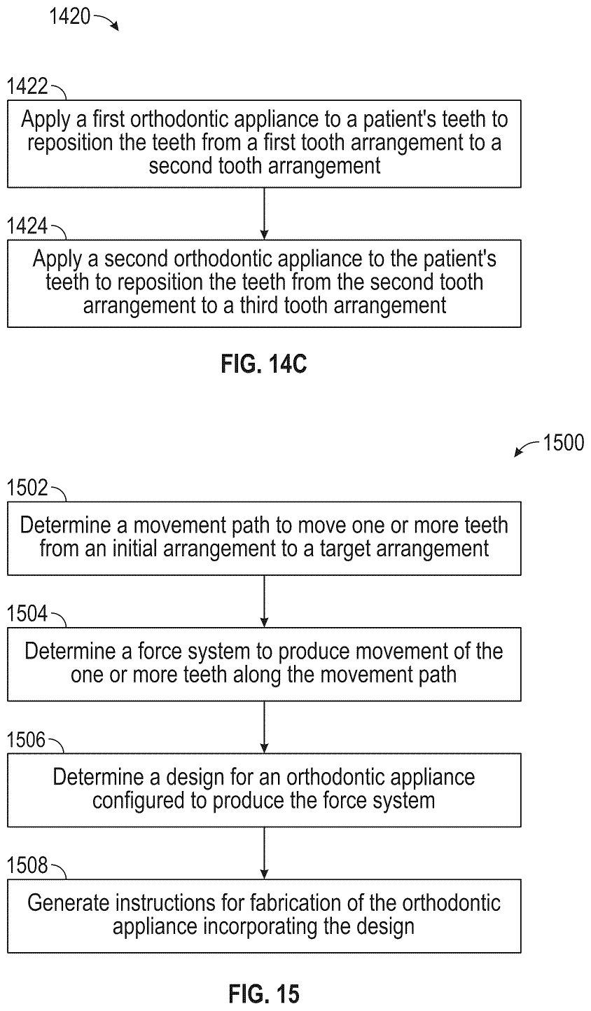

FIG. 15 illustrates a method 1500 for designing an orthodontic appliance, in accordance with embodiments of the present technology. The method 1500 can be applied to any embodiment of the orthodontic appliances described herein. Some or all of the steps of the method 1500 can be performed by any suitable data processing system or device, e.g., one or more processors configured with suitable instructions.

In block 1502, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1504, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1504 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1506, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1508, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1500 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1500 may be performed with any suitable fabrication system or device, such as the embodiments described herein. Some of the steps may be optional, e.g., the process of block 1504 can be omitted, such that the orthodontic appliance is designed based on the desired tooth movements and/or determined tooth movement path, rather than based on a force system. Moreover, the order of the steps can be varied as desired.

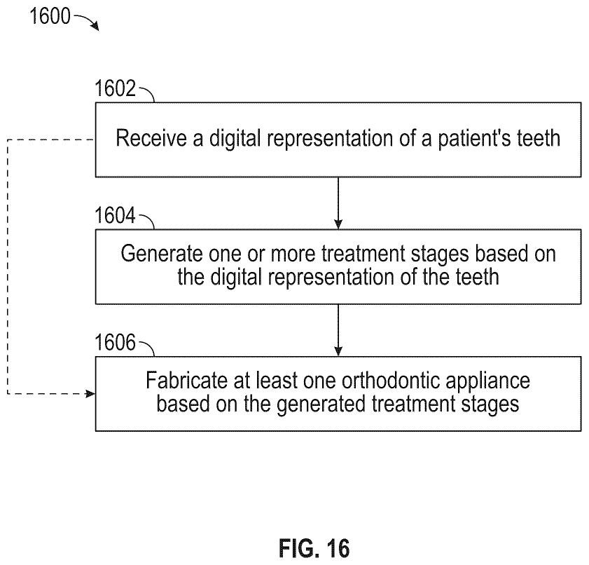

FIG. 16 illustrates a method 1600 for digitally planning an orthodontic treatment and/or design or fabrication of an appliance, in accordance with embodiments. The method 1600 can be applied to any of the treatment procedures described herein and can be performed by any suitable data processing system.

In block 1602, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1604, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1606, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 16, design and/or fabrication of an orthodontic appliance, and perhaps a particular orthodontic treatment, may include use of a representation of the patient's teeth (e.g., including receiving a digital representation of the patient's teeth (block 1602)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### Examples

The following examples are included to further describe some aspects of the present technology, and should not be used to limit the scope of the technology.

Example 1. A system for processing additively manufactured objects, the system comprising:
a frame configured to couple to a substrate carrying an additively manufactured object having excess material thereon; and
an actuator configured to rotate the frame to remove at least some of the excess material from the additively manufactured object,
wherein during the rotation of the frame, the frame allows the substrate to move to a plurality of different tilt angles relative to the frame.

Example 2. The system of Example 1, wherein the movement of the substrate to the plurality of different tilt angles facilitates removal of the excess material from the additively manufactured object.

Example 3. The system of Example 1 or 2, wherein the frame comprises a rotatable coupling mechanism for coupling to the substrate, wherein the rotatable coupling mechanism allows the substrate to rotate to the plurality of different tilt angles relative to the frame.

Example 4. The system of Example 3, wherein the rotatable coupling mechanism allows the substrate to rotate relative to the frame around a lateral axis that is substantially orthogonal to an axis of rotation of the frame.

Example 5. The system of Example 3 or 4, wherein the rotatable coupling mechanism allows the substrate to rotate relative to the frame around a vertical axis that is substantially parallel to an axis of rotation of the frame.

Example 6. The system of any one of Examples 1 to 5, wherein the plurality of different tilt angles comprise a plurality of vertical tilt angles.

Example 7. The system of any one of Examples 1 to 6, wherein the plurality of different tilt angles comprise a plurality of lateral tilt angles.

Example 8. The system of any one of Examples 1 to 7, wherein the rotation of the frame exerts a force on the substrate that causes the substrate to move to the plurality of different tilt angles.

Example 9. The system of any one of Examples 1 to 8, wherein the actuator is configured to rotate the frame at a plurality of different rotation speeds to cause the substrate to move to the plurality of different tilt angles.

Example 10. The system of Example 9, wherein the actuator is configured to rotate the frame at a first rotation speed and a second rotation speed different from the first rotation speed.

Example 11. The system of Example 10, wherein the rotation of the frame at the first rotation speed produces a first force that causes the substrate to move to a first tilt angle, and wherein the rotation of the frame at the second rotation speed produces a second force that causes the substrate to move to a second tilt angle, the second tilt angle being different from the first tilt angle.

Example 12. The system of any one of Examples 1 to 11, further comprising:
a support coupled to the frame, and
a spring element configured to couple the substrate to the support.

Example 13. The system of Example 12, wherein:
the spring element is movable between a resting length and an extended length,
when the spring element is in the resting length, the substrate is positioned at a first tilt angle relative to the frame, and
when the spring element is in the extended length, the substrate is positioned at a second tilt angle relative to the frame.

Example 14. The system of Example 13, wherein the rotation of the frame causes the spring element to transition from the resting length to the extended length.

Example 15. The system of any one of Examples 12 to 14, wherein the spring element is configured to couple to a first side portion of the substrate, and wherein the frame is configured to couple to a second side portion of the substrate opposite the first side portion.

Example 16. The system of any one of Examples 1 to 15, further comprising:
a holder rotatably coupled to the frame, wherein the holder is configured to support the substrate,
an arm comprising a first end coupled to the holder and a second end extending inward toward a center of rotation of the frame, and
a weight coupled to the second end of the arm.

Example 17. The system of Example 16, wherein:
the holder is rotatable between a first configuration in which the weight is positioned proximate to the center of rotation of the frame and a second configuration in which the weight is positioned away from the center of rotation of the frame,
when the holder is in the first configuration, the substrate is positioned at a first tilt angle relative to the frame, and
when the holder is in the second configuration, the substrate is positioned at a second tilt angle relative to the frame.

Example 18. The system of Example 17, wherein the rotation of the frame causes the holder to rotate from the first configuration to the second configuration.

Example 19. The system of any one of Examples 16 to 18, further comprising a stopper configured to constrain rotation of the holder relative to the frame.

Example 20. The system of any one of Examples 1 to 19, further comprising a sensor configured to measure a tilt angle of the substrate.

Example 21. The system of Example 20, wherein the sensor is configured to provide an indication of whether the substrate achieves a target tilt angle during the rotation of the frame.

Example 22. The system of any one of Examples 1 to 21, further comprising a second actuator coupling the substrate to the frame, wherein the second actuator is configured to move the substrate to the plurality of different tilt angles.

Example 23. The system of any one of Examples 1 to 22, wherein the additively manufactured object is fabricated from a curable resin, and wherein the excess material comprises uncured or partially cured resin.

Example 24. The system of any one of Examples 1 to 23, wherein the substrate is a build platform for the additively manufactured object.

Example 25. The system of any one of Examples 1 to 24, wherein the additively manufactured object is a dental appliance.

Example 26. A method comprising:
coupling a substrate to a frame, wherein the substrate is carrying an additively manufactured object having excess material thereon;
rotating the frame to remove at least some of the excess material from the additively manufactured object; and
moving the substrate to a plurality of different tilt angles relative to the frame during the rotation of the frame.

Example 27. The method of Example 26, wherein the movement of the substrate to the plurality of different tilt angles facilitates removal of the excess material from the additively manufactured object.

Example 28. The method of Example 26 or 27, wherein the substrate is rotated relative to the frame during the rotation of the frame.

Example 29. The method of Example 28, wherein the substrate is rotated around a lateral axis that is substantially orthogonal to an axis of rotation of the frame.

Example 30. The method of Example 28 or 29, wherein the substrate is rotated around a vertical axis that is substantially parallel to an axis of rotation of the frame.

Example 31. The method of any one of Examples 26 to 30, wherein the plurality of different tilt angles comprise a plurality of vertical tilt angles.

Example 32. The method of any one of Examples 26 to 31, wherein the plurality of different tilt angles comprise a plurality of lateral tilt angles.

Example 33. The method of any one of Examples 26 to 32, wherein the rotation of the frame exerts a force on the substrate that causes the substrate to move to the plurality of different tilt angles.

Example 34. The method of any one of Examples 26 to 33, wherein the frame is rotated at a plurality of different rotation speeds to cause the substrate to move to the plurality of different tilt angles.

Example 35. The method of Example 34, wherein rotating the frame comprises:
rotating the frame at a first rotation speed, and
rotating the frame at a second rotation speed different from the first rotation speed.

Example 36. The method of Example 35, wherein the rotation of the frame at the first rotation speed produces a first force that causes the substrate to move to a first tilt angle, and wherein the rotation of the frame at the second rotation speed produces a second force that causes the substrate to move to a second tilt angle, the second tilt angle being different from the first tilt angle.

Example 37. The method of any one of Examples 26 to 36, wherein the substrate is coupled to a spring element, and wherein a length of the spring element changes during the rotation of the frame to cause the substrate to move to the plurality of different tilt angles.

Example 38. The method of Example 37, wherein the spring element is at a resting length before the rotation of the frame, and wherein the spring element transitions to an extended length during the rotation of the frame.

Example 39. The method of any one of Examples 26 to 38, wherein the substrate is supported by a holder including a weight, and wherein a location of the weight changes during the rotation of the frame to cause the substrate to move to the plurality of different tilt angles.

Example 40. The method of Example 39, wherein the weight is at a location proximate to a center of rotation of the frame before the rotation of the frame, and wherein the weight moves to a location away from the center of rotation of the frame during the rotation of the frame.

Example 41. The method of any one of Examples 26 to 40, further comprising measuring a tilt angle of the substrate.

Example 42. The method of Example 41, further comprising outputting an indication of whether the substrate achieved a target tilt angle during the rotation of the frame.

Example 43. The method of any one of Examples 26 to 42, wherein the substrate is moved to the plurality of different tilt angles via an actuator.

Example 44. The method of any one of Examples 26 to 43, wherein the additively manufactured object is fabricated from a curable resin, and wherein the excess material comprises uncured or partially cured resin.

Example 45. The method of any one of Examples 26 to 44, wherein the substrate is a build platform for the additively manufactured object.

Example 46. The method of any one of Examples 26 to 45, wherein the additively manufactured object is a dental appliance.

### Conclusion

Although many of the embodiments are described above with respect to systems, devices, and methods for post-processing of dental appliances, the technology is applicable to other applications and/or other approaches, such as post-processing of other types of additively manufactured objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-16.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A system for processing additively manufactured objects, the system comprising:
a frame configured to couple to a substrate carrying an additively manufactured object having excess material thereon; and
an actuator configured to rotate the frame to remove at least some of the excess material from the additively manufactured object,
wherein during the rotation of the frame, the frame allows the substrate to move to a plurality of different tilt angles relative to the frame.

2. The system of claim 1, wherein the movement of the substrate to the plurality of different tilt angles facilitates removal of the excess material from the additively manufactured object.

3. The system of claim 1, wherein the frame comprises a rotatable coupling mechanism for coupling to the substrate, wherein the rotatable coupling mechanism allows the substrate to rotate to the plurality of different tilt angles relative to the frame.

4. The system of claim 3, wherein the rotatable coupling mechanism allows the substrate to rotate relative to the frame around a lateral axis that is substantially orthogonal to an axis of rotation of the frame.

5. The system of claim 3, wherein the rotatable coupling mechanism allows the substrate to rotate relative to the frame around a vertical axis that is substantially parallel to an axis of rotation of the frame.

6. The system of claim 1, wherein the rotation of the frame exerts a force on the substrate that causes the substrate to move to the plurality of different tilt angles.

7. The system of claim 1, wherein the actuator is configured to rotate the frame at a plurality of different rotation speeds to cause the substrate to move to the plurality of different tilt angles.

8. The system of claim 1, further comprising:
a support coupled to the frame, and
a spring element configured to couple the substrate to the support.

9. The system of claim 8, wherein:
the spring element is movable between a resting length and an extended length,
when the spring element is in the resting length, the substrate is positioned at a first tilt angle relative to the frame, and
when the spring element is in the extended length, the substrate is positioned at a second tilt angle relative to the frame.

10. The system of claim 1, further comprising:
a holder rotatably coupled to the frame, wherein the holder is configured to support the substrate,
an arm comprising a first end coupled to the holder and a second end extending inward toward a center of rotation of the frame, and
a weight coupled to the second end of the arm.

11. A method comprising:
coupling a substrate to a frame, wherein the substrate is carrying an additively manufactured object having excess material thereon;
rotating the frame to remove at least some of the excess material from the additively manufactured object; and
moving the substrate to a plurality of different tilt angles relative to the frame during the rotation of the frame.

12. The method of claim 11, wherein the movement of the substrate to the plurality of different tilt angles facilitates removal of the excess material from the additively manufactured object.

13. The method of claim 11, wherein the substrate is rotated relative to the frame during the rotation of the frame.

14. The method of claim 13, wherein the substrate is rotated around a lateral axis that is substantially orthogonal to an axis of rotation of the frame.

15. The method of claim 13, wherein the substrate is rotated around a vertical axis that is substantially parallel to an axis of rotation of the frame.

16. The method of claim 11, wherein the rotation of the frame exerts a force on the substrate that causes the substrate to move to the plurality of different tilt angles.

17. The method of claim 11, wherein the frame is rotated at a plurality of different rotation speeds to cause the substrate to move to the plurality of different tilt angles.

18. The method of claim 11, wherein the substrate is coupled to a spring element, and wherein a length of the spring element changes during the rotation of the frame to cause the substrate to move to the plurality of different tilt angles.

19. The method of claim 11, wherein the substrate is supported by a holder including a weight, and wherein a location of the weight changes during the rotation of the frame to cause the substrate to move to the plurality of different tilt angles.

20. The method of claim 11, further comprising:
measuring a tilt angle of the substrate, and
outputting an indication of whether the substrate achieved a target tilt angle during the rotation of the frame.
